(19) United States
(12) Patent Application Publication
(10) Pub. No.: US 2025/0388512 A1
(43) Pub. Date: Dec. 25, 2025

(54) HIGH EFFICIENCY ACID-BASE LEACHING METHODS AND SYSTEMS

(71) Applicant: Sublime Systems, Inc., Somerville, MA (US)

(72) Inventors: Michael C. STERN, Sudbury, MA (US); Jesse D. BENCK, Wakefield, MA (US); Yet-Ming CHIANG, Wellesley, MA (US)

(73) Assignee: Sublime Systems, Inc., Somerville, MA (US)

(21) Appl. No.: 19/110,657

(22) PCT Filed: Sep. 12, 2023
(86) PCT No.: PCT/US2023/073967

§ 371 Date: Mar. 11, 2025

Related U.S. Application Data
(60) Provisional application No. 63/375,307, filed on Sep. 12, 2022.
(60) Provisional application No. 63/417,272, filed on Oct. 18, 2022.

(51) Int. Cl. C04B 7/12; C01B 33/12; C01F 5/14; C01F 7/60; C01F 11/02; C01F 11/46; C01G 49/04; C01G 49/06; C04B 7/06; C04B 11/00; C22B 3/10; C22B 3/16; C22B 21/00; C22B 26/20; C22B 26/22; C25B 1/22

(52) U.S. Cl. CPC C04B 7/12; C01B 33/126; C01F 5/14; C01F 7/60; C01F 11/02; C01F 11/46; C01G 49/04; C01G 49/06; C04B 7/06; C04B 11/005; C22B 3/10; C22B 3/16; C22B 21/0015; C22B 26/20; C22B 26/22; C25B 1/22

(57) ABSTRACT

Disclosed herein are acid-base leaching methods and systems. Specifically, the systems and methods can include supplying an iron and/or aluminum feed material and an acid to a first reaction chamber; supplying a first leachate comprising iron and/or aluminum salts or cations from the first reaction chamber and a calcium feed material to a second reaction chamber to form a solid comprising iron and/or aluminum; supplying a second leachate from the second reaction chamber comprising alkaline earth metal salts or cations and a base to a third reaction chamber to form a precipitated alkaline earth metal product.

### CROSS-REFERENCE TO RELATED APPLICATIONS

This application claims the benefit of U.S. Provisional Application No. 63/375,307 filed Sep. 12, 2022 and U.S. Provisional Application No. 63/417,272 filed Oct. 18, 2022, the entire contents of each of which are incorporated herein by reference.

### FIELD OF THE DISCLOSURE

This disclosure relates to systems and methods for acid-base leaching. More specifically, this disclosure relates to systems and methods for acid-base leaching, wherein an acid can be used to produce a leachate and the leachate can act as an acid to perform another acid leaching reaction.

### BACKGROUND OF THE DISCLOSURE

Acid leaching of ores, ashes, slags, and other waste residues containing metal oxides can allow for the extraction of many desired materials, such as precious metals, transition metals, alkali metals, oxides thereof, and the like. The cost of acid leaching can largely depend on the amount of acid consumed during the leaching process. Conventional leaching processes involve the addition of a sufficient amount of acid to simultaneously dissolve all the desired materials at a low pH and then the addition of a base to sequentially precipitate individual component streams.

Conventional processes for the extraction of alkali metals, such as calcium (Ca) and magnesium (Mg), can use carbon dioxide or carbonates to precipitate calcium carbonate and/or magnesium carbonate and then calcine the carbonated salts to form calcium oxide and/or magnesium oxide. Calcining carbonated salts, however, can lead to greater environmental impact due to carbon emissions from the combustion of heating fuel and due to the release of carbon dioxide from the carbonated salts.

Silicates and/or aluminosilicates are insoluble in most acid leaching processes. Depending on the pretreatment of the materials being leached and the conditions of the leaching, the silicate and/or aluminosilicate solids may form polymerized networks known as silica gels. Silica gels may have some desirable properties, such as high surface area, but can have negative properties including high liquid retention, poor filterability, and/or poor flow properties. Silicates, silicas, and aluminosilicates can be effective pozzolans and/or supplemental cementitious materials (SCMs) for the production of pozzolanic cement, but specific pretreatment and reaction conditions may be necessary to form materials suitable for this purpose. In many cases, these silicates and aluminosilicates are disposed of as tailings and not monetized.

### SUMMARY OF THE DISCLOSURE

Disclosed herein are improved leaching methods and systems that reduce acid consumption and carbon dioxide emissions, thereby reducing costs and environmental impacts. In addition, the methods and systems disclosed herein can generate suitable pozzolanic materials and/or SCMs for cement production and/or can generate concentrated streams of other saleable products such as aluminum, iron, calcium, silicon, and/or magnesium oxides and/or hydroxides to reduce waste and improve the economics of the process.

Disclosed herein are methods and systems of reducing overall acid usage for acid-base leaching. The amount of acid supplied to leaching systems can be significantly reduced by the methods and systems described herein. Specifically, an acid can be used to produce a first leachate (or process stream) and that first leachate can act as an acid to perform another acid leaching reaction. The second leachate from the second leaching reaction can act as an acid to perform a third acid leaching reaction. This process can be repeated again and again with various acid leaching reactions in series and/or parallel. By using a leachate from a prior acid leaching reaction to perform a subsequent acid leaching reaction, the amount of acid used may be reduced by more than about 10%, more than about 25%, more than about 50%, or more than about 75%, compared to conventional techniques where components (i.e., feed materials or feed sources) are simultaneously dissolved in an acid and then sequentially precipitated.

Various embodiments of the present disclosure provide systems and methods for extracting desired materials from industrial waste materials, industrial byproducts, and/or natural minerals.

In some embodiments, a method includes reacting a first feed material comprising iron and/or aluminum with an acid to produce (e.g., directly produce) a first leachate comprising iron and/or aluminum cations; reacting the first leachate with a second feed material comprising calcium to produce (e.g., directly produce) a second leachate comprising calcium cations and a solid comprising iron and/or aluminum oxides or hydroxides; reacting at least a portion of the second leachate to form a calcium oxide or hydroxide; and regenerating the acid. In some embodiments, the first feed material comprises a natural rock or mineral comprising basalt, gabbro, amphibolite, feldspar, pyroxene, anorthosite, anorsite, or combinations thereof. In some embodiments, the first feed material comprises iron oxide and/or aluminum oxide concentrations greater than 10 wt. % as measured by X-ray Fluorescence (XRF). In some embodiments, the second feed material comprises a calcium oxide concentration greater than 20 wt. % as measured by XRF. In some embodiments, the second feed material comprise an industrial byproduct comprising ash, kiln dust, slag, recycled concrete, or a combination thereof. In some embodiments, reacting the first feed material with the acid produces (e.g., directly produces) a second solid comprising a pozzolanic material. In some embodiments, the pozzolanic material has a strength activity index of greater than 75% at 7 and 28 days. In some embodiments, the acid comprises an inorganic acid. In some embodiments, the inorganic acid comprises hydrochloric acid. In some embodiments, the acid comprises an organic acid. In some embodiments, the organic acid comprises acetic acid. In some embodiments, the acid is regenerated using electrolysis. In some embodiments, the calcium oxide or hydroxide is calcium hydroxide. In some embodiments, at least the portion of the second leachate is reacted with a base to form the calcium hydroxide. In some embodiments, the method includes producing the base and regenerating the acid using electrolysis. In some embodiments, the method includes producing (e.g., directly producing) a cementitious material using at least a portion of the first and/or second solid and the calcium oxide or hydroxide. In some embodiments, the cementitious material comprises at least a portion of the solid comprising iron and/or aluminum oxides or hydroxides. In some embodiments, the method includes reacting at least a portion of the second leachate with a base to form (e.g., directly produce) a third solid comprising magnesium oxides or hydroxides. In some embodiments, ferrous ions are precipitated separately through reaction with a base to form either ferrous or ferric oxides or hydroxides.

In some embodiments, a method of preparing a cementitious material includes reacting a first feed material comprising iron and/or aluminum with an acid to produce (e.g., directly produce) a first leachate comprising iron and/or aluminum cations and a first solid comprising silicon; reacting the first leachate with a second feed material comprising calcium to produce (e.g., directly produce) a second leachate comprising calcium cations and a second solid comprising iron and/or aluminum oxides or hydroxides; reacting at least a portion of the second leachate to form a third solid comprising calcium oxide or hydroxide and a salt solution; combining a portion of the third solid with a portion of the first and/or second solid to form a cementitious material; and regenerating the acid using the salt solution. In some embodiments, the cementitious material comprises the second solid and a sulfate source comprising gypsum, anhydrite, and/or calcium sulfate hemihydrate. In some embodiments, combining the portion of the third solid with the portion of the first and/or second solid comprises heating the combination in a kiln to create the cementitious material.

In some embodiments, an acid-base leaching method includes supplying an iron-containing material and an acid to a first reaction chamber to form a first process stream comprising an iron salt; supplying the first process stream and a calcium source feed material to a second reaction chamber to form a precipitated iron oxide (Fe₂O₃ and/or FeO) product and a second process stream comprising alkaline earth metal salts; supplying the second process stream and a base to a third reaction chamber to form a precipitated first alkali metal product and a third process stream; and regenerating the acid using the third process stream. In some embodiments, the supplying an iron-containing material comprises: supplying an iron source feed material comprising industrial waste directly to the first reactor; or recycling a portion of the iron product to the first reactor. In some embodiments, the iron salt comprises ferric chloride (FeCl₃); and the first alkali metal product comprises magnesium hydroxide (Mg(OH)₂). In some embodiments, the acid comprises hydrochloric acid and the base comprises sodium hydroxide. In some embodiments, the method includes forming an insoluble silicon dioxide (SiO₂) or aluminosilicate product in the first reaction chamber. In some embodiments, the method includes supplying the third process stream and the base to a fourth reaction chamber to form a precipitated second alkaline earth metal product and a brine stream and supplying the brine stream to an electrolyzer configured to generate the acid and the base. In some embodiments, the fourth reaction chamber is maintained at a higher pH than the third reaction chamber by the addition of the base to the fourth reaction chamber. In some embodiments, the method incudes forming a fourth process stream comprising aluminum oxide (Al₂O₃) and silicon dioxide (SiO₂) in the first reactor; supplying the fourth process stream and the base to a fifth reaction chamber to form a fifth process stream comprising dissolved sodium aluminate and a solid silicon dioxide product; supplying the fifth process stream to a sixth reaction chamber to form a precipitated aluminum product comprising aluminum oxide (Al₂O₃) and/or aluminum hydroxide (Al(OH)₃); and heating the base prior to supplying the base to the fifth reaction chamber. In some embodiments, supplying the fifth process stream to a sixth reaction chamber comprises cooling the sixth reaction chamber, such that chemical reactions occur at a lower temperature in the sixth reaction chamber than in the fifth reaction chamber and the base is supplied to the third reaction chamber from the sixth reaction chamber. In some embodiments, the method includes blending the silicon dioxide product and the aluminum product to for a pozzolan and using the pozzolan to make a construction material.

In some embodiments, an acid-base leaching method includes supplying an iron source feed material and an acid to a first reaction chamber to form a first process stream comprising an iron salt and a fourth process stream comprising precipitated silicon dioxide (SiO₂), aluminum hydroxide (Al(OH)₃), and/or aluminum oxide (Al₂O₃); supplying the first process stream and a calcium source feed material to a second reaction chamber to form a second process stream comprising alkaline earth metal salts and a precipitated iron oxide (Fe₂O₃ and/or FeO) product; supplying the second process stream and a first ammonia stream to a third reaction chamber to form a third process stream comprising calcium chloride CaCl₂) and ammonium chloride (NH₄Cl) and a precipitated magnesium hydroxide Mg(OH)₂) product; supplying the third process stream and a base to a fourth reaction chamber to form a precipitated calcium hydroxide Ca(OH)₂ product, a brine stream, and a second ammonia stream; supplying the brine stream to an electrolyzer configured to generate the acid and a base; supplying the fourth process stream, an ammonia salt, and the base to a fifth reaction chamber to generate a first ammonia stream and a fifth process stream comprising dissolved silicon dioxide and aluminum oxide; supplying the fifth process stream and the second ammonia stream to a sixth reaction chamber to form a precipitated aluminosilicate product and the dissolved ammonia salt; and regenerating the acid from the brine stream. In some embodiments, the ammonia salt comprises ammonium fluoride (NH₄F) and/or ammonium bifluoride (NH₄F₂). In some embodiments, the method includes using the calcium hydroxide product and the aluminosilicate product to form a construction material.

In some embodiments, an acid-base leaching method includes supplying calcium sulfate (CaSO₄) and an acid to a first reaction chamber to form a first process stream comprising calcium ions (Ca⁺) and bisulfate ions (2HSO₄⁻) and a solid silicon dioxide (SiO₂) product; supplying the first process stream and iron oxide (Fe₂O₃) to a second reaction chamber to form a second process stream comprising ferric chloride (FeCl₃) and precipitated calcium sulfate (CaSO₄) product; supplying the second process stream and aluminum oxide (Al₂O₃) to a third reaction chamber to form a third process stream comprising aluminum chloride (AlCl₃) and a precipitated iron oxide product; supplying the third process stream and a feed material to a fourth reaction chamber to form a fourth process stream comprising alkaline earth metal salts and a precipitated aluminum oxide product; supplying the fourth process stream and a base to a fifth reaction chamber to form a fifth process stream comprising calcium chloride and a precipitated magnesium hydroxide Mg(OH)₂) product; supplying the fifth process stream and a base to a sixth reaction chamber to form a brine stream and a precipitated calcium hydroxide Ca(OH)₂ product; and providing the brine stream to an electrolyzer to generate the acid and the base. In some embodiments, the calcium sulfate provided to the first reaction chamber is recycled from the calcium sulfate product; the iron oxide provided to the second reaction chamber is recycled from the iron oxide product; and the aluminum oxide provided to the third reaction chamber is recycled from the aluminum oxide product. In some embodiments, the method includes controlling the pH of each reaction chamber, such that the first reaction chamber has the lowest pH and the second, third, fourth, fifth, and sixth reaction chambers have successively higher pH's. In some embodiments, the pH of the first chamber ranges from about −0.5 to about −1.5; the pH of the fifth chamber ranges from about 9.5 to about 10.5; and the pH of the sixth chamber ranges from about 12 to about 13.

In some embodiments, an acid-base leaching method includes supplying calcium sulfate (CaSO₄) and an acid to a first reaction chamber to form a first process stream comprising calcium ions (Ca⁺) and bisulfate ions (2HSO₄⁻) and a solid silicon dioxide (SiO₂) product; supplying the first process stream and iron source feed material to a second reaction chamber to form a second process stream comprising ferric chloride (FeCl₃) and precipitated calcium sulfate (CaSO₄) product; supplying the second process stream and aluminum source feed material to a third reaction chamber to form a third process stream comprising aluminum chloride (AlCl₃) and a precipitated iron oxide product; supplying the third process stream and a calcium source feed material to a fourth reaction chamber to form a fourth process stream comprising alkaline earth metal salts and a precipitated aluminum oxide product; supplying the fourth process stream and a base to a fifth reaction chamber to form a fifth process stream comprising calcium chloride and a precipitated magnesium hydroxide Mg(OH)₂) product; supplying the fifth process stream and a base to a sixth reaction chamber to form a brine stream and a precipitated calcium hydroxide Ca(OH)₂ product; and providing the brine stream to an electrolyzer to generate the acid and the base. In some embodiments, the iron source feed material, the aluminum source feed material, and the calcium source feed material are industrial waste products. In some embodiments, the method includes controlling the pH of each reaction chamber, such that the first reaction chamber has the lowest pH and the second, third, fourth, fifth, and sixth reaction chambers have successively higher pH's.

In some embodiments, an acid-base leaching method includes supplying an acid, a silica source feed material, and a silica recycle stream to a first reaction chamber to generate a first process stream comprising unreacted acid and to generate a fifth process stream comprising crystalline silica; supplying the first process stream, a calcium and magnesium source feed material, an Fe/Al/Si recycle stream comprising amorphous silica, iron hydroxide (Fe(OH)₂ and/or Fe(OH)₃), aluminum oxide (Al₂O₃), and/or aluminum hydroxide (Al₂(OH)₃), and an iron and aluminum source feed material, to a second reaction chamber to generate an amorphous silica product and to generate a second process stream comprising an aluminum salt and an iron salt, wherein the silica recycle stream comprises a portion of the amorphous silica product; supplying the second process stream, a decarbonated calcium and magnesium source feed material, and a calcium carbonate source feed material to a third reaction chamber to generate a third process stream comprising a calcium salt and a magnesium salt and to generate a seventh process stream comprising amorphous silica, iron hydroxide, aluminum hydroxide, and/or aluminum oxide, wherein the Fe/Al/Si recycle stream comprises a portion of the seventh process stream; supplying the fifth process stream and an ammonia salt to a sixth reaction chamber to generate ammonia, a sixth process stream comprising aqueous silica, and a rare earth element and/or platinum group metal product; and supplying the sixth process stream and the ammonia to a seventh reaction chamber to generate an amorphous silica product and the ammonia salt, wherein the sixth reaction chamber has a lower pressure and/or temperature than the seventh reaction chamber to promote the condensation of the ammonia in the sixth reaction chamber. In some embodiments, the method includes supplying the seventh process stream and a base to an eighth reaction chamber to generate an eighth process stream comprising an aluminum salt and to generate an Fe/Si product comprising iron hydroxide (Fe(OH)₂ and/or Fe(OH)₃) and amorphous silica; and supplying the eighth process stream to a nineth reaction chamber to generate aluminum hydroxide and the base, wherein the eighth reaction chamber is maintained at a higher temperature than the nineth reaction chamber, in order to promote the generation of the aluminum salt. In some embodiments, the method includes supplying the Fe/Si product to a separation device to generate an amorphous silica product and an iron hydroxide (Fe(OH)₂ and/or Fe(OH)₃) product. In some embodiments, the method includes supplying the third process stream and the base to a fourth reaction chamber to generate a magnesium oxide product and a fourth process stream comprising a calcium salt; and supplying the base and the fourth process stream to a fifth reaction chamber to generate brine and a calcium hydroxide product.

In some embodiments, an acid-base leaching method comprises: supplying an iron and/or aluminum-containing material and an acid to a first reaction chamber to form a first process stream comprising an iron and/or aluminum salt; supplying the first process stream and a calcium source feed material to a second reaction chamber to form a precipitated iron oxide and/or hydroxide (e.g., Fe₂O₃, Fe(OH)₃, FeOOH, Fe(OH)₂, Fe₃O₄, and/or FeO) and/or aluminum oxide and/or hydroxide (e.g., Al₂O₃, Al(OH)₃, and/or AlOOH) product and a second process stream comprising alkaline earth metal salts (e.g., salts of calcium or magnesium); and reacting the second process stream in a third reaction chamber to form a first alkali metal product (e.g., calcium and/or magnesium hydroxide and/or oxide).

In some embodiments, an acid-base leaching method comprises: supplying an iron and/or aluminum source feed material and an acid to a first reaction chamber to form a first process stream comprising an iron and/or aluminum salt and a fourth process stream comprising insoluble silicates and aluminosilicates; supplying the first process stream and a calcium source feed material to a second reaction chamber to form a second process stream comprising alkaline earth metal salts and a precipitated iron and/or aluminum oxide and/or hydroxide product.

In some embodiments, the method may include supplying the second process stream and a first ammonia stream to a third reaction chamber to form a third process stream comprising calcium chloride CaCl₂) and ammonium chloride (NH₄Cl) and a precipitated magnesium hydroxide Mg(OH)₂) product; supplying the third process stream and a base to a fourth reaction chamber to form a precipitated calcium hydroxide Ca(OH)₂ product, a brine stream, and a second ammonia stream; supplying the brine stream to an electrolyzer configured to generate the acid and a base; supplying the fourth process stream, an ammonia salt, and the base to a fifth reaction chamber to generate a first ammonia stream and a fifth process stream comprising dissolved silicon dioxide and aluminum oxide; and supplying the fifth process stream and the second ammonia stream to a sixth reaction chamber to form a precipitated aluminosilicate product and the dissolved ammonia salt.

In some embodiments, an acid-base leaching method comprising: supplying calcium sulfate (CaSO₄) and an acid to a first reaction chamber to form a first process stream comprising calcium ions (Ca⁺) and bisulfate ions (2HSO₄⁻) and a solid silicate and/or aluminosilicate product; supplying the first process stream and iron oxide (Fe₂O₃) to a second reaction chamber to form a second process stream comprising ferric chloride (FeCl₃) and precipitated calcium sulfate (CaSO₄) product; supplying the second process stream and aluminum oxide (Al₂O₃) to a third reaction chamber to form a third process stream comprising aluminum chloride (AlCl₃) and a precipitated iron oxide product; supplying the third process stream and a feed material to a fourth reaction chamber to form a fourth process stream comprising alkaline earth metal salts and a precipitated aluminum oxide product; supplying the fourth process stream and a base to a fifth reaction chamber to form a fifth process stream comprising calcium chloride and a precipitated magnesium hydroxide (Mg(OH)₂) product; supplying the fifth process stream and a base to a sixth reaction chamber to form a brine stream and a precipitated calcium hydroxide (Ca(OH)₂) product; and providing the brine stream to an electrolyzer to generate the acid and the base.

In some embodiments, an acid-base leaching method comprises: supplying calcium sulfate (CaSO₄) and an acid to a first reaction chamber to form a first process stream comprising calcium ions (Ca⁺) and bisulfate ions (2HSO₄⁻) and a solid aluminosilicate product; supplying the first process stream and iron source feed material to a second reaction chamber to form a second process stream comprising ferric chloride (FeCl₃) and precipitated calcium sulfate (CaSO₄) product; supplying the second process stream and aluminum source feed material to a third reaction chamber to form a third process stream comprising aluminum chloride (AlCl₃) and a precipitated iron oxide product; supplying the third process stream and a calcium source feed material to a fourth reaction chamber to form a fourth process stream comprising alkaline earth metal salts and a precipitated aluminum oxide product; supplying the fourth process stream and a base to a fifth reaction chamber to form a fifth process stream comprising calcium chloride and a precipitated magnesium hydroxide (Mg(OH)₂) product; supplying the fifth process stream and a base to a sixth reaction chamber to form a brine stream and a precipitated calcium hydroxide (Ca(OH)₂) product; and providing the brine stream to an electrolyzer to generate the acid and the base.

In some embodiments, where the iron and/or aluminum source includes a portion of iron at a oxidation state less than three (e.g., Fe(II) or Fe(II/III)), these low oxidation iron species (e.g., ferrous ions) may be recovered in an additional precipitation step after the precipitation of aluminum but before the precipitation of alkali earth metals disclosed herein. In some embodiments, the ferrous iron species will be precipitated as their respective hydroxides and/or oxides. In some embodiments, the ferrous irons will also be oxidized to ferric ions (Fe(III)) and precipitated as ferric hydroxides and/or oxides. In some embodiments, the ferrous ions can be precipitated separately through reaction with a base to form either ferrous or ferric oxides and/or hydroxides. In some embodiments, the magnesium and low oxidation iron species may be precipitated together. In some embodiments, the reactors for low oxidation iron removal may involve the injection of oxidants such as oxygen, air, peroxides, or hypochlorite to oxidize the iron to its ferric state and then precipitate out ferric oxides and/or hydroxides. In some embodiments, the system may be heated to promote the oxidation of the iron coupled with the release of hydrogen gas during the solid recovery process. In some embodiments, the iron oxide products may be valuable iron oxide pigments or in other forms of commercial value.

In some embodiments, an acid-base leaching method comprise: supplying an acid, a silica source feed material, and a silica recycle stream to a first reaction chamber to generate a first process stream comprising unreacted acid and to generate a fifth process stream comprising crystalline silica; supplying the first process stream, a calcium and magnesium source feed material, an Fe/Al/Si recycle stream comprising amorphous silica, iron hydroxide (Fe(OH)₂ and Fe(OH)₃), aluminum oxide (Al₂O₃), and/or aluminum hydroxide (Al(OH)₃), and an iron and aluminum source feed material, to a second reaction chamber to generate a silica product and to generate a second process stream comprising an aluminum salt and an iron salt, wherein the silica recycle stream comprises a portion of the silica product; supplying the second process stream, a decarbonated calcium and magnesium source feed material, and a calcium carbonate source feed material to a third reaction chamber to generate a third process stream comprising a calcium salt and a magnesium salt and to generate a seventh process stream comprising amorphous silica, iron hydroxide, aluminum hydroxide, and/or aluminum oxide, wherein the Fe/Al/Si recycle stream comprises a portion of the seventh process stream; supplying the fifth process stream and an ammonia salt to a sixth reaction chamber to generate ammonia, a sixth process stream comprising aqueous silica, and a rare earth element and/or platinum group metal product; and supplying the sixth process stream and the ammonia to a seventh reaction chamber to generate an amorphous silica product and the ammonia salt, wherein the sixth reaction chamber has a lower pressure and/or temperature than the seventh reaction chamber to promote the condensation of the ammonia in the sixth reaction chamber.

The embodiments disclosed above are only examples, and the scope of this disclosure is not limited to them. Particular embodiments may include all, some, or none of the components, elements, features, functions, operations, or steps of the embodiments disclosed above. Embodiments according to the disclosure herein are in particular disclosed in the attached claims directed to a methods and systems, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 illustrates an exemplary schematic diagram of a single-feed leaching system and a corresponding leaching method process flow in accordance with some embodiments disclosed herein.

FIG. 2 illustrates an exemplary schematic diagram of a dual-feed leaching system and a corresponding leaching method process flow in accordance with some embodiments disclosed herein.

FIG. 3 illustrates an exemplary schematic diagram of a dual-feed leaching system with additional aluminum production and a corresponding leaching method process flow in accordance with some embodiments disclosed herein.

FIG. 4 illustrates an exemplary schematic diagram of a dual-feed leaching system utilizing ammonia compounds and a corresponding leaching method process flow in accordance with some embodiments disclosed herein.

FIG. 5 illustrates an exemplary schematic diagram of a single-feed leaching system with multiple recycle streams and a corresponding leaching method process flow in accordance with some embodiments disclosed herein.

FIG. 6 illustrates an exemplary schematic diagram of a multi-feed leaching system and a corresponding process flow in accordance with some embodiments disclosed herein.

FIG. 7 illustrates a schematic diagram of a multi-feed leaching system including multiple purification systems and a corresponding process flow in accordance with some embodiments disclosed herein.

FIG. 8 illustrates a schematic diagram of an acid/base silica modification system in accordance with some embodiments disclosed herein.

FIG. 9 illustrates a schematic diagram of an aluminum bifluoride cycle silica modification system in accordance with some embodiments disclosed herein.

FIG. 10 illustrates a schematic diagram of a thermal swing aluminosilicate in accordance with some embodiments disclosed herein.

FIG. 11 illustrates an exemplary schematic diagram of a dual-feed leaching system and an exemplary molar flow rate of such a system in accordance with some embodiments disclosed herein.

FIG. 12 illustrates an exemplary schematic diagram of a dual-feed leaching system sent to the same reaction chamber and an exemplary molar flow rate of such a system in accordance with some embodiments disclosed herein.

FIG. 13 illustrates an exemplary diagram of a set of experiments performed to demonstrate the concept using a basalt feedstock as the iron and/or aluminum source and lime as the calcium source in a leaching system in accordance with some embodiments disclosed herein.

FIG. 14 is a diagram of a set of experiments performed to demonstrate the concept using a concrete fines feedstock as the iron and/or aluminum source and lime as the calcium source in a leaching system in accordance with some embodiments disclosed herein.

In the Figures, like reference numerals refer to like components unless otherwise stated herein.

### DETAILED DESCRIPTION OF THE DISCLOSURE

Disclosed herein are methods and systems of reducing overall acid usage for acid-base leaching. Specifically, the methods and systems disclosed herein can utilize a leachate (or process stream) from a first acid-base reaction to perform a second acid leaching reaction.

Various embodiments provide counter-current and/or cross-current leaching systems and methods configured to simultaneously generate multiple concentrated component streams including calcium sulfates, iron oxides, alumina, magnesium hydroxide, calcium hydroxide, silica or the like, from one or more sources, such as industrial waste products/streams. Various embodiments may be configured to reduce acid consumption by transitioning active acidic species from a supplied acid into acids derived from desired components extracted by leaching, such as bisulfates, bisulfites, iron (III) salts, aluminum (III) salts, and/or transition metal salts.

By utilizing one or more embodied acids generated from the dissolution of a leached material to perform a subsequent (or other) leaching step rather than relying on acid supplied to the system, the amount of acid used (i.e., acid supplied to the overall system) may be reduced by more than about 75%, more than about 50%, more than about 25%, or more than about 10% (for the same amount of feedstock material), as compared to conventional techniques where all components (i.e., all feedstock material) are simultaneously dissolved then sequentially precipitated or conventional techniques where acid is supplied from elsewhere to perform all the leaching/dissolution steps.

In dual feed and multi-feed systems where multiple feed streams are provided, significant acid reduction can be achieved by strategically ordering the feeds to the various reaction chambers and the respective leachates from these reaction chambers. For example, ordering the feeds to start with iron containing materials, then aluminum containing materials, then alkali earth containing materials (calcium and/or magnesium) may result in significant supplied acid reduction. In this example, the dissolved iron species (ferric salts) can act as an acid to dissolve the aluminum species, which, in turn, can act as an acid to dissolve the alkali earth species. In this manner, the amount of acid used (i.e., acid supplied to the overall system) may be reduced by more than about 75%, more than about 50%, more than about 25%, or more than about 10% (for the same amount of feedstock material), as compared to conventional techniques where all components (i.e., all feedstock materials) are simultaneously dissolved then sequentially precipitated or conventional techniques where acid is supplied from elsewhere to perform all the leaching/dissolution steps.

An additional benefit to the systems and methods disclosed herein, is many of the iron, aluminum, and/or calcium bearing feedstocks are industrial wastes or byproducts with minimal utility and value such as mining tailings, ashes, slags, residues (bauxite residue or aluminum dross), demolition debris (concrete fines), returned concrete sludge from a reclaimer, and/or kiln dusts. In addition to producing useful materials, the systems and methods disclosed herein can divert large quantities of such byproducts and wastes from landfilling and can process already ponded or landfilled materials to reduce the need to constantly maintain and monitor their storage. Using such materials can reduce the need to mine virgin materials and, therefore, can reduce emissions and environmental impacts associated with such mining.

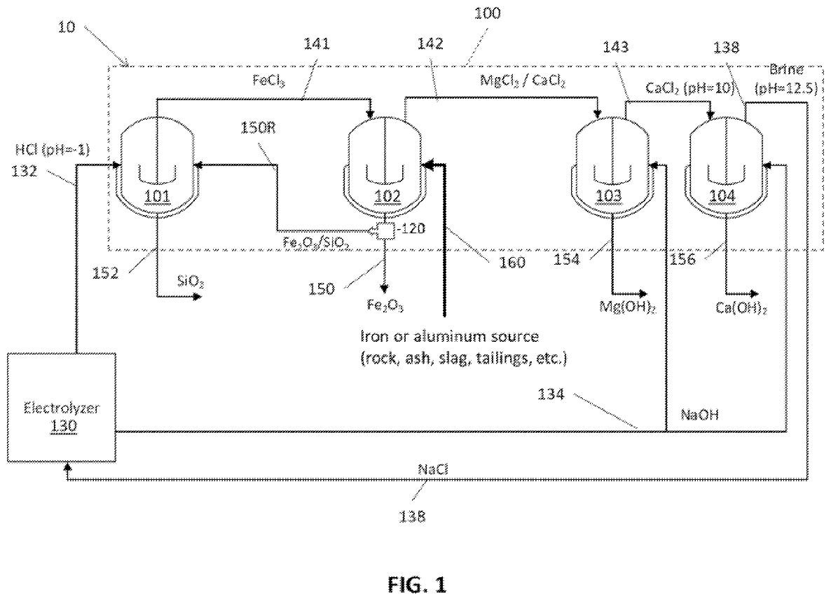

FIG. 1 is a schematic diagram of a single-feed counter-current leaching system 10 and a corresponding leaching method process flow, according to some embodiments of the present disclosure. Referring to FIG. 1, the system 10 may include a reactor system 100 and an electrolyzer 130.

In some embodiments, the electrolyzer 130 may be configured to generate an acid and/or a base. Electrolyzers that produce acids and/or base, and systems that use said acids and/or bases for chemical dissolution and precipitation, have been described in International Patent Application No. PCT/US2020/022672, filed Mar. 13, 2020, and International Patent Application No. PCT/US2020/013837, filed Jan. 16, 2020, which are incorporated herein, in their entireties, by reference. Electrochemical reactors used for the purpose of cyclic acid gas scrubbing were described by Stern et al. in U.S. Pat. No. 10,625,209, which is incorporated herein, in its entirety, by reference.

The electrolyzer 130 may be configured to use electrochemical methods to generate an acid (e.g., a strong or weak acid) 132 and a base (e.g., a strong or weak base) 134 for subsequent leaching and/or alkaline metal precipitation. In some embodiments, the electrolyzer 130 may operate using methods including salt splitting, bipolar membrane electrodialysis, and/or chlor-alkali electrolysis. In some embodiments, the acid 132 may have a pH of 7 or less, a pH of 6 or less, a pH of 5 or less, a pH of 4 or less, a pH of 3 or less, a pH of 2 or less, a pH of 1 or less, such as a pH ranging from about −0.5 to about −1.5, or about −1. In some embodiments, the acid can be a strong acid. In some embodiments, the strong acid can be hydrochloric acid (HCl), nitric acid (HNO₃), sulfuric acid (H₂SO₄), perchloric acid (HClO₄), or the like, other strong acids capable of dissolving aluminum and/or iron, or combinations thereof. In some embodiments, the acid can be an organic and/or an inorganic acid. In some embodiments the acid can be a weak acid. In some embodiments, the weak acid can include acetic acid, lactic acid, carbonic acid, bicarbonate, carbonates, benzoic acid, bisulfite, bisulfate, monobasic phosphate, dibasic phosphate, tribasic phosphate, citric acid, hydrofluoric acid, oxalic acid, sulfurous acid, etc., other weak acids capable of dissolving aluminum and/or iron, or combinations thereof.

In some embodiments, the base 134 may have a pH of greater than 7, a pH of greater than 8, a pH of greater than 9, a pH of greater than 10, a pH of greater than 11, a pH of greater than 12, a pH of greater than 13, such as a pH ranging from about 14 to about 15. In some embodiments, the base can be a strong base. In some embodiments, the strong base can be sodium hydroxide, potassium hydroxide, lithium hydroxide, other alkali metal bases or alkaline earth metal bases or the like, other strong bases capable of precipitating aluminum, iron, magnesium, and/or calcium compounds (e.g., oxides and/or hydroxides), or combinations thereof. In some embodiments, the base can be an organic and/or an inorganic base. In some embodiments, the base can be a weak base. In some embodiments, the weak base can include ammonia, amines, carbonates, bicarbonates, dibasic phosphates, tribasic phosphate, borates, thiols, phenols, etc., other bases acids capable of precipitating aluminum, iron, magnesium, and/or calcium compounds (e.g., oxides and/or hydroxides), or combinations thereof. In some embodiments, the electrolyzer 130 may be configured such that the acid 132 includes hydrochloric acid (HCl) and the base 134 includes sodium hydroxide (NaOH).

In some embodiments, the reactor system may include one or multiple reaction chambers. In some embodiments, the reaction chambers can be at least one of a silica reactor, an aluminum reactor, an iron reactor, a magnesium reactor, or a calcium reactor. In some embodiments, the reactor system 100 may include a first reaction chamber 101 (e.g., silica and/or aluminum reactor), a second reaction chamber 102 (e.g., aluminum and/or iron reactor), a third reaction chamber 103 (e.g., magnesium reactor), and/or a fourth reaction chamber 104 (e.g., calcium reactor). In some embodiments, the reaction chambers may be settlement/leaching tanks or reactors, such as batch reactors, stirred-tank reactors, etc. In some embodiments, the reaction chambers may be fluidly connected to one another and to the electrolyzer by conduits, pipes, manifolds, or the like. For example, the chambers 101, 102, 103, 104 may be fluidly connected to one another and to the electrolyzer 130 by conduits, pipes, manifolds, or the like. In some embodiments, the acid may be output from an acid outlet of an electrolyzer and provided to a first reaction chamber (e.g., for a dissolution/leaching reaction). For example, the acid 132 may be output from an acid outlet of the electrolyzer 130 and provided to the first reaction chamber 101. In some embodiments, the base may be output from a base outlet of an electrolyzer and sent to one or more reaction chambers (e.g., for a precipitation reaction). For example, the base 134 may be output from a base outlet of the electrolyzer 130 and sent to a third 103 and/or fourth chamber 104. In some embodiments, a salt or brine stream generated from one or more of the reaction chambers can be sent to the electrolyzer to regenerate the acid and/or base. For example, a salt or brine stream 138 (e.g., a NaCl aqueous solution) generated in a reaction chamber (e.g., fourth chamber 104) may be provided to a salt or brine inlet of the electrolyzer 130 and used to generate the acid 132 and/or the base 134. In some embodiments, these salt streams can have a pH greater than 7, a pH greater than 8, a pH greater than 9, a pH greater than 10, a pH greater than 11, a pH greater than 12, or a pH greater than 13. For example, the brine stream 138 may have a pH of greater than 11, such as a pH ranging from about 12 to about 13, or about 12.5.

In some embodiments, one or more feed materials may be provided to one or more of the reaction chambers. In some embodiments, the feed material can include at least one of iron, aluminum, calcium, or silicon. In some embodiments, a first feed material to a reaction chamber can include iron and/or aluminum (and/or magnesium and/or silicon). In some embodiments, a second feed material to a reaction chamber can include calcium (and/or magnesium and/or silicon). In some embodiments, a feed material can include ore, rock, slag, ash, minerals, tailing, byproduct, recycled concrete, industrial waste, etc., which may contain iron, silicon, aluminum, magnesium, and/or calcium materials, in addition to other metals and/or waste materials. In some embodiments, a feed material can be an iron and/or aluminum source. In some embodiments, the iron and/or aluminum source can be rock, ore, minerals, ash, slag, tailings, etc., or combinations thereof. In some embodiments, an iron and/or aluminum source (or feed material) can be a natural rock or mineral comprising basalt, gabbro, amphibolite, feldspar, pyroxene, anorthosite, anorsite, or combinations thereof. In some embodiments, a feed material can be a calcium and/or magnesium source. In some embodiments, the calcium and/or magnesium source can be a decarbonated calcium and/or magnesium source. A decarbonized or decarbonated source is one that contains a low proportion of carbonate salts and, therefore, releases a small quantity of carbon dioxide when added to the system. In some embodiments, a decarbonated source can release an amount of carbon dioxide (g) per kg of source/feed of less than about 220 grams when contacted by acid. In contrast, pure limestone has about 440 grams of carbon dioxide per kg. Examples of decarbonated calcium sources can include slags, ashes, recycled concrete fines or returned concrete sludge, certain minerals such as wollastonite, and certain lime or cement kiln dusts, or combinations thereof. In some embodiments, the calcium source (or feed material) can be (an industrial byproduct or waste) rock, ore, minerals, ash, slag, kiln dust, tailings, recycled concrete, etc., or combinations thereof.

In some embodiments, industrial wastes and byproducts, such as slags, ashes, mining tailings, returned concrete, concrete demolition debris, and/or waste streams may be of environmental concern since weathering may result in leaching of various metals from such waste products. For example, red mud (i.e., bauxite residue), is a waste product generated during the processing of bauxite into alumina using the Bayer process and may include various oxide or hydroxide compounds, such as iron oxide (Fe₂O₃ and/or FeO), iron hydroxide (Fe(OH)₂ and/or Fe(OH)₃) aluminum oxide (Al₂O₃), aluminum hydroxide (Al(OH)₃), titanium dioxide TiO₂, calcium oxide (CaO), silicon dioxide (SiO₂), and/or sodium oxide (Na₂O). Slag can be a byproduct of metal ore smelting that may include silicon oxide and other metal oxides such as calcium oxide, magnesium oxide, iron oxide, and/or aluminum oxide. While slag from some blast furnaces may be useable in cement and concrete after appropriate grinding, slags from blast oxygen furnaces and electric arc furnaces may not be suitable for such direct applications but can be used in the methods and systems disclosed herein. Fly ash, bottom ash, and/or ponded ash can be a coal combustion product that may contain silicon dioxide (amorphous and crystalline), aluminum oxide, iron oxide, and/or calcium oxide as primary components, depending on the type of combusted coal. Other combustion ashes derived from the combustion of other solid fuels such as biomass or municipal waste may have similar properties to those of coal ashes. In many cases, ashes derived from sources other than coal often have impurities such as chlorides that make them unsuitable for use is cement and concrete through traditional means but can be used in the methods and systems disclosed herein. In some embodiments, ores and naturally occurring minerals that may be leached include silicates such as wollastonite, olivine, serpentine, basalt, gabbro, amphibolite, anorthite, anorthosite, allanite, allanite ores, feldspars including plagioclase feldspars and other silicates that may incorporate calcium, magnesium, iron, aluminum, platinum group elements, and/or rare earth elements. Similarly, aluminosilicates incorporating calcium, magnesium, iron, platinum group elements, and/or rare earth elements may also be leached. Carbonates of calcium and/or magnesium may also be leached. Ores and minerals can also include mafic or ultramafic rocks. In some embodiments, clays such as kaolin or bentonite, may also be suitable feedstocks or feed materials. Any and/or all of the above, can be a feed material for one or more reaction chambers of the systems and methods disclosed herein.

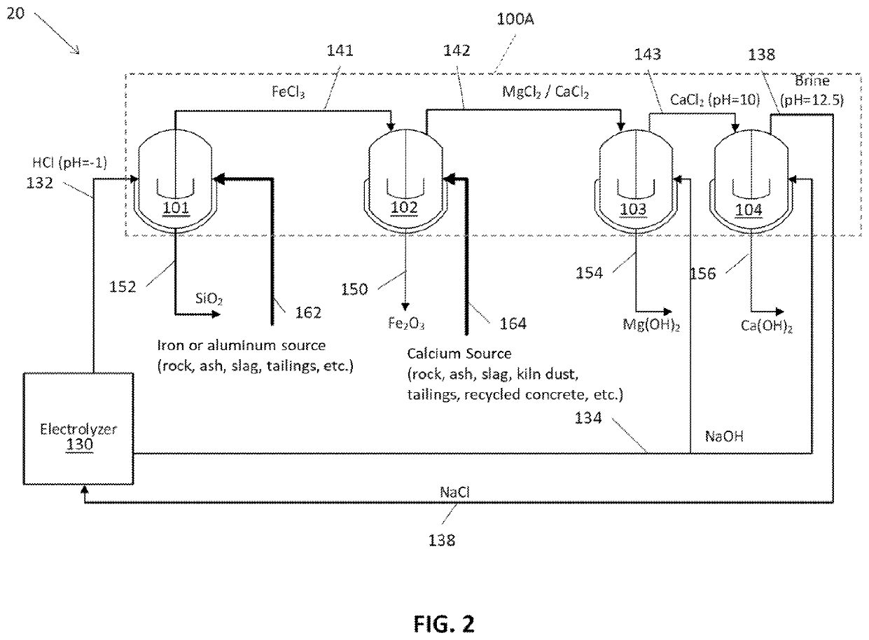

In some embodiments, a feed material 160 may be provided to the second chamber 102 (and first chamber as shown in FIG. 2 explained below). The feed material 160 may include ore, rock, slag, ash, tailing, byproduct, recycled concrete, industrial waste, etc., or combinations thereof, and may contain iron, silicon, aluminum, magnesium, and/or calcium materials, in addition to other metals and/or waste materials. In some embodiments, a first leachate or process stream can be generated from a first reaction chamber. For examples, a first leachate or process stream 141 may be generated in the first reaction chamber 101. The first process stream may be a liquid fraction or leachate including an acidic iron and/or aluminum material (e.g., iron and/or aluminum cations) may be output to a second reaction chamber (e.g., 102). In some embodiments, the first process stream or leachate may include an acidic iron and/or aluminum salt or cation such as iron trichloride (FeCl₃) or aluminum tetrachloride. In some embodiments, the first process stream or leachate can react with a feed material in a reaction chamber. For example, iron and/or aluminum salts or cations (e.g., trichlorides and/or terachlorides) may react with the feed material 160 for a time period and at a temperature and pH sufficient to form a second process stream or leachate 142 and an iron and/or aluminum product 150 (and/or silicon product).

The iron and/or aluminum product 150 may be a solids phase including precipitated iron and/or aluminum oxides and/or hydroxides and/or other precipitated components extracted from the feed material 160. For example, the iron and/or aluminum product 150 may include silicon (e.g., silicas, silicates, and/or aluminosilicates) in some embodiments. In some embodiments, the system and method can include an iron and/or aluminum recycle stream 150R. In some embodiments, the iron and/or aluminum recycle stream 150R may be separated from the iron and/or aluminum product 150 and recycled back to the first chamber 101. In some embodiments, the iron and/or aluminum recycle stream can include a silicon compound such as silica (e.g., silicon dioxide), silicates, and/or aluminosilicates. In some embodiments, the system 10 may include a separation device 120 configured to generate the iron and/or aluminum recycle stream 150R. For example, the separation device 120 may include a standard tee and/or wye pipe fitting. In some embodiments, the separation device 120 may be a hydrocyclone, elutriation tank, and/or centrifuge, in order to selectively recycle components based on particle size and/or a density.

In some embodiments, iron and/or aluminum may be reacted with an acid generated by an electrolyzer to generate the first process stream or leachate (that can include iron and/or aluminum salts or cations). In some embodiments, the iron and/or aluminum (with also silicon (e.g., silica, silicates, and/or aluminosilicates) in some embodiments) recycled to the first chamber 101 may be reacted with the acid (e.g., HCl) generated by the electrolyzer 130 to generate the iron and/or aluminum salts and/or cations included in the first process stream or leachate 141. In some embodiments, the amount of iron and/or aluminum recycled to the first chamber 101 may be selected on order to generate an amount of iron and/or aluminum salt or cation that is sufficient to leach all or substantially all of the calcium and/or magnesium components included in the feed stream 160. In some embodiments, a first product can be an output from a first reaction chamber. In some embodiments, a pozzolan product (e.g., a component containing silicon such as silicas, silicates, and/or aluminosilicates) may be an output from the first reaction chamber. For example, a pozzolan product (e.g., a silicon product) 152 may be output from the first chamber 101. In some embodiments, the pozzolan product 152 may be a solids fraction that can include precipitated silicas, silicates, and/or aluminosilicates as a primary component. In some embodiments, the pozzolan product 152 may be collected and stored in a suitable container. In some embodiments, the pozzolan product can have a strength activity index, as defined in ASTM C311 and ASTM C618, of greater than about 25%, of greater than about 50%, or of greater than about 75% at 7 and 28 days.

In some embodiments, a second process stream or leachate (from a second reaction chamber) can be a liquid fraction or leachate that includes an alkaline earth metal (e.g., calcium and/or magnesium) compound (e.g., salt and/or cation). For example, the second process stream 142 may be a liquid fraction or leachate including alkaline earth metal compounds (e.g., salts or cations). For example, the second process stream or leachate may include alkaline earth metal salts and/or cations, such as magnesium chloride (MgCl₂) and calcium chloride (CaCl₂)), which may be generated by reactions between the iron trichloride, aluminum tetrachloride, and/or hydrochloric acid and the alkaline earth metal containing components (e.g., magnesium and/or calcium containing components) of the feed material.

In some embodiments, second process stream or leachate can be reacted in a third reaction chamber with a base generated by the electrolyzer to form a third product (e.g., magnesium and/or calcium product), which can be a solids product. For example, the second process stream or leachate 142 may be reacted in the third chamber 103 with the base (e.g., NaOH) generated by the electrolyzer 130 to form a magnesium (and/or calcium) product 154 and a third process stream or leachate 143. In some embodiments, the third process stream can be a liquid fraction or leachate that includes alkaline earth metal salts and/or cations (e.g., calcium). For example, the third process stream 143 may be a liquid fraction or leachate including calcium chloride. In some embodiments, the third process stream 143 may have a pH greater than 8, a pH of greater than 9, such as a pH ranging from about 10 to about 12. In some embodiments, the third reaction chamber can produce a product stream 154. In some embodiments, the product stream can include a magnesium product. In some embodiments, the product stream 154 can be a solids fraction including a precipitated product generated by the reaction of the second leachate with the base from the electrolyzer. In some embodiments, the solids product 154 may be a magnesium product 154 that can be a solids fraction including precipitated magnesium hydroxide Mg(OH)₂ generated by reacting magnesium chloride and the base.

In some embodiments, the third process stream or leachate can be reacted with the base from the electrolyzer in a fourth reaction chamber to form a fourth product 156 (via precipitation, for example). In some embodiments, the third process stream or leachate 143 (e.g., calcium chloride) may be reacted with the base (e.g., NaOH) in the fourth chamber 104 to form a fourth product 156 (e.g., calcium product) and the brine or salt stream 138. The fourth product 156 may be a solids fraction and can include a precipitated solid from the fourth reaction chamber (e.g., calcium hydroxide). The product 156 may be collected and stored in a suitable container. In some embodiments, the brine or salt stream 138 may be recycled to the electrolyzer 130. In some embodiments, the salt or brine stream can be sent to the electrolyzer in order to regenerate the acid and/or base.

In some embodiments, the pH within each of the reaction chambers may be controlled by selective component addition to selectively promote formation of products from the reaction chambers. In some embodiments, each of the chambers 101, 102, 103, 104 may be controlled by selective component addition, in order to selectively promote the formation of the products 150, 152, 154, 156. For example, the first reaction chamber 101 may have the lowest pH, and the second-fourth reaction chambers 102, 103, 104, may have progressively higher pH's.

In some embodiments, the system may be preloaded with reactants. For example, acids and/or bases may be loaded into the reaction chambers prior to supplying any feed material. In some embodiments, the third chamber 103 may be omitted if the feed material 160 has a low magnesium content. Similarly, in some embodiments, the fourth chamber 104 may be omitted if the feed material 160 has a low calcium content.

FIG. 2 is a schematic diagram of a dual-feed leaching system 20 and a corresponding leaching method process flow, according to various embodiments of the present disclosure. The system 20 may be similar to the system 10 of FIG. 1. As such, the differences therebetween will be the focus of the following.

Referring to FIG. 2, the system 20 may include a modified reactor system 100A configured to receive an iron and/or aluminum source feed material 162 and a calcium and/or magnesium source feed material 164. These feed materials can be any of the feed materials disclosed herein. In some embodiments, the iron and/or aluminum source feed material 162 may be provided directly to a first reactor chamber 101 and the calcium and/or magnesium source feed material 164 may be provided directly to a second reactor chamber 102. In some embodiments, the system 20 may not require a recycle stream between the first reaction chamber 101 and the second reaction chamber 102.

In some embodiments, the iron and/or aluminum source feed material may include more iron and/or aluminum than the calcium and/or magnesium source feed material, and the calcium and/or magnesium source feed material may include more calcium and/or magnesium than the iron and/or aluminum source feed material, on a weight percentage basis. In some embodiments, the iron and/or aluminum source feed material can include an amount of calcium and/or magnesium greater than about 1 wt. %, greater than about 5 wt. %, greater than about 10 wt. %, greater than about 15 wt. %, greater than about 20 wt. %, or greater than about 25 wt. % as measured by Inductively Coupled Plasma Spectroscopy (ICP). In some embodiments, the iron and/or aluminum source feed material can include an amount of calcium and/or magnesium oxide greater than about 1 wt. %, greater than about 5 wt. %, greater than about 10 wt. %, greater than about 15 wt. %, greater than about 20 wt. %, or greater than about 25 wt. % as measured by X-ray Fluorescence (XRF). In some embodiments, the iron and/or aluminum source feed material can include an amount of calcium and/or magnesium less than about 30 wt. %, less than about 25 wt. %, less than about 20 wt. %, less than about 15 wt. %, or less than about 10 wt. % as measured by ICP. In some embodiments, the iron and/or aluminum source feed material can include an amount of calcium and/or magnesium oxide less than about 30 wt. %, less than about 25 wt. %, less than about 20 wt. %, less than about 15 wt. %, or less than about 10 wt. % as measured by XRF.

In some embodiments, the iron and/or aluminum feed material can include iron and/or aluminum concentrations greater than about 5 wt. %, greater than about 10 wt. %, greater than about 15 wt. %, greater than about 20 wt. %, greater than about 25 wt. %, greater than about 30 wt. %, greater than about 40 wt. %, or greater than about 45 wt. % as measured by Inductively Coupled Plasma Spectroscopy (ICP). In some embodiments, the iron and/or aluminum feed material can include iron and/or aluminum concentrations less than about 50 wt. %, less than about 40 wt. %, less than about 30 wt. %, or less than about 25 wt. % as measured by ICP. In some embodiments, the iron and/or aluminum feed material can include iron and/or aluminum oxide concentrations greater than about 5 wt. %, greater than about 10 wt. %, greater than about 15 wt. %, greater than about 20 wt. %, greater than about 25 wt. %, greater than about 30 wt. %, greater than about 40 wt. %, or greater than about 45 wt. % as measured by XRF. In some embodiments, the iron and/or aluminum oxide feed material can include iron and/or aluminum oxide concentrations less than about 50 wt. %, less than about 40 wt. %, less than about 30 wt. %, or less than about 25 wt. % as measured by XRF.

In some embodiments, the iron and/or aluminum feed material can include silicon concentrations greater than about 10 wt. %, greater than about 15 wt. %, greater than about 25 wt. %, greater than about 35 wt. %, greater than about 40 wt. %, greater than about 50 wt. %, greater than about 65 wt. %, or greater than 75 wt. % as measured by ICP. In some embodiments, the iron and/or aluminum feed material can include silicon concentrations less than about 80 wt. %, less than about 75 wt. %, less than about 65 wt. %, less than about 50 wt. %, less than about 45 wt. %, less than about 35 wt. %, less than about 30 wt. %, or less than about 25 wt. % as measured by ICP. In some embodiments, the iron and/or aluminum feed material can include silicon oxide concentrations greater than about 10 wt. %, greater than about 15 wt. %, greater than about 25 wt. %, greater than about 35 wt. %, greater than about 40 wt. %, greater than about 50 wt. %, greater than about 65 wt. %, or greater than 75 wt. % as measured by XRF. In some embodiments, the iron and/or aluminum feed material can include silicon oxide concentrations less than about 80 wt. %, less than about 75 wt. %, less than about 65 wt. %, less than about 50 wt. %, less than about 45 wt. %, less than about 35 wt. %, less than about 30 wt. %, or less than about 25 wt. % as measured by XRF.

In some embodiments, the calcium and/or magnesium feed material can include calcium concentrations greater than about 10 wt. %, greater than about 15 wt. %, greater than about 20 wt. %, greater than about 25 wt. %, greater than about 30 wt. %, greater than about 35 wt. %, greater than about 40 wt. %, greater than about 45 wt. %, or greater than about 50 wt. % as measured by ICP. In some embodiments, the calcium and/or magnesium feed material can include calcium oxide concentrations greater than about 10 wt. %, greater than about 15 wt. %, greater than about 20 wt. %, greater than about 25 wt. %, greater than about 30 wt. %, greater than about 35 wt. %, greater than about 40 wt. %, greater than about 45 wt. %, or greater than about 50 wt. % as measured by XRF. In some embodiments, the calcium and/or magnesium feed material can include iron and/or aluminum concentrations less than about 50 wt. %, less than about 40 wt. %, less than about 30 wt. %, or less than about 25 wt. % as measured by ICP. In some embodiments, the calcium and/or magnesium feed material can include iron and/or aluminum oxide concentrations less than about 50 wt. %, less than about 40 wt. %, less than about 30 wt. %, or less than about 25 wt. % as measured by XRF.

In some embodiments, the iron and/or aluminum source feed material 162 may be an industrial waste product such as red mud, iron slag, olivine, aluminum dross, tailings or a natural mineral or the like (or combinations thereof), that includes iron and/or aluminum (e.g., iron and/or aluminum oxide), silicas, silicates, and/or aluminosilicates as a primary component. In some embodiments, the iron and/or aluminum source feed material 162 may also include other metals (e.g., metal oxides), such as silicon, calcium, and/or magnesium. In some embodiments, the iron and/or aluminum source feed material 162 may also include a significant amount of silicon (e.g., silicas, silicates, and/or aluminosilicates) in addition to other secondary components.

In some embodiments, the calcium and/or magnesium source feed material 164 may be an industrial waste product such as fly ash, mine tailings, slag, recycled concrete, kiln dust, or natural mineral that includes calcium (e.g., calcium oxide, calcium carbonate, and/or calcium silicate) as a primary component. The calcium and/or magnesium source feed material 164 may also include wollastonite, limestones, dolomite, basalt rocks, or the like having a high calcium content. The calcium and/or magnesium source feed material 164 may also include magnesium (e.g., magnesium oxide) and/or additional secondary components. In some embodiments, the calcium and/or magnesium source feed material 164 may have a lower silicon content than the iron and/or aluminum source feed material 162, on a weight percentage basis, in some embodiments. In some embodiments, the calcium and/or magnesium feed material can include silicon concentrations greater than about 1 wt. %, greater than about 5 wt. %, greater than about 10 wt. %, greater than about 15 wt. %, or greater than 20 wt. % as measured by ICP. In some embodiments, the calcium and/or magnesium feed material can include silicon concentrations less than about 75 wt. %, less than about 50 wt. %, less than about 35 wt. %, less than about 30 wt. %, less than about 25 wt. %, less than about 20 wt. %, less than about 25 wt. %, or less than about 10 wt. % as measured by ICP. In some embodiments, the calcium and/or magnesium feed material can include silicon oxide concentrations greater than about 1 wt. %, greater than about 5 wt. %, greater than about 10 wt. %, greater than about 15 wt. %, or greater than 20 wt. % as measured by XRF. In some embodiments, the calcium and/or magnesium feed material can include silicon oxide concentrations less than about 75 wt. %, less than about 50 wt. %, less than about 35 wt. %, less than about 30 wt. %, less than about 25 wt. %, less than about 20 wt. %, less than about 25 wt. %, or less than about 10 wt. % as measured by XRF.

In some embodiments, the iron and/or aluminum feed material 162 can be reacted with an acid 132 of electrolyzer 130 in first reaction chamber 101 to produce (e.g., directly produce) a first process stream or leachate 141. Similar to FIG. 1, the first process stream may be a liquid fraction or leachate including an acidic iron and/or aluminum material (e.g., iron and/or aluminum cations) and may be output to a second reaction chamber (e.g., 102). In some embodiments, a pozzolan product (e.g., a silicon product such as silicas, silicates, and/or aluminosilicates) 152 may be output from the first chamber 101. In some embodiments, the pozzolan product 152 may be a solids fraction that can include precipitated silicon compound (e.g., silicas such as silicon dioxide, silicates, and/or aluminosilicates) as a primary component. In some embodiments, the pozzolan product 152 may be collected and stored in a suitable container. The calcium and/or magnesium source 164 can be reacted with the first process stream or leachate of the first reaction chamber 101 to produce (e.g., directly produce) a second process stream or leachate 142. Similar to FIG. 1, the second process stream or leachate (from a second reaction chamber) can be a liquid fraction or leachate that includes an alkaline earth metal (e.g., calcium and/or magnesium) compound (e.g., salt and/or cation). In some embodiments, an iron and/or aluminum product 150 may be an output from the second reaction chamber 102. In some embodiments, the iron and/or aluminum product 150 may be a solids phase including precipitated iron and/or aluminum oxides and/or hydroxides and/or other precipitated components extracted from the feed materials 162 or 164. For example, the iron and/or aluminum product 150 may include silicon (e.g., silicas such as silicon dioxide, silicates, and/or aluminosilicates) in some embodiments.

In some embodiments, the second process stream or leachate 142 can be reacted with a base 134 of electrolyzer 130 in a third reaction chamber 103 to produce (e.g., directly produce) a third process stream or leachate 143. In some embodiments, the third process stream can be a liquid fraction or leachate that includes alkaline earth metal salts and/or cations (e.g., calcium). For example, the third process stream 143 may be a liquid fraction or leachate including calcium chloride. In some embodiments, the third reaction chamber can produce a product stream 154. In some embodiments, the product stream can include a magnesium product. In some embodiments, the product stream 154 can be a solids fraction including a precipitated product generated by the reaction of the second leachate with the base from the electrolyzer. In some embodiments, the solids product 154 may be a magnesium product 154 that can be a solids fraction including precipitated magnesium hydroxide Mg(OH)₂ generated by reacting magnesium chloride and the base.

In some embodiments, the third process stream or leachate can be reacted with the base 134 from the electrolyzer 130 in a fourth reaction chamber 104 to form (e.g., directly produce) a fourth product 156 (via precipitation, for example). In some embodiments, the third process stream or leachate 143 (e.g., calcium chloride) may be reacted with the base (e.g., NaOH) in the fourth chamber 104 to form (e.g., directly produce) a fourth product 156 (e.g., calcium product) and the brine or salt stream 138. The fourth product 156 may be a solids fraction and can include a precipitated solid from the fourth reaction chamber (e.g., calcium hydroxide). The product 156 may be collected and stored in a suitable container. In some embodiments, the brine or salt stream 138 may be recycled to the electrolyzer 130. In some embodiments, the salt or brine stream can be sent to the electrolyzer in order to regenerate the acid and/or base.

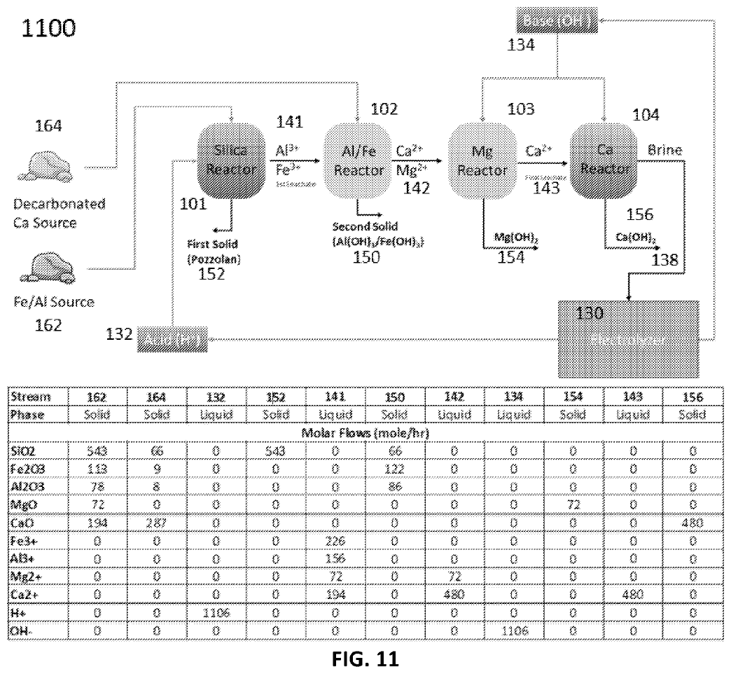

FIG. 11 illustrates a system similar to that of FIG. 2. Referring to FIG. 11, system 1100 may be configured to receive an iron and/or aluminum source 162 and a calcium source 164. In some embodiments, a first reaction chamber 101 can be configured to receive the iron and/or aluminum source and an acid 132 (from an electrolyzer 130) such that the iron and/or aluminum source reacts with the acid to produce product 152 (e.g., a solid pozzolan product such as silicas, silicates, and/or aluminosilicates) and a first process stream or leachate 141 (which can include iron and/or aluminum salts or cations). In some embodiments, the product 152 can include silicas, silicates, and/or aluminosilicates. In some embodiments, a second reaction chamber 102 can be configured to receive the first process stream or leachate 141 and a calcium source 164 such that the calcium source reacts with the first process stream or leachate to produce product 150 (e.g., a solid aluminum and/or iron product that can include aluminum and/or iron oxides or hydroxides) and a second process stream or leachate 142 (which can include calcium and/or magnesium salts or cations). In some embodiments, a third reaction chamber 103 can be configured to receive the second process stream or leachate 142 and a base 134 (from an electrolyzer 130) such that the second process stream or leachate reacts with the base to produce product 154 (e.g., a magnesium solid product such as magnesium oxide or hydroxide) and a third process stream or leachate 143 (which can include calcium salts or cations). In some embodiments, a fourth reaction chamber 104 can be configured to receive the third process stream or leachate 143 and a base 134 (from an electrolyzer 130) such that the third process stream or leachate reacts with the base to produce product 156 (e.g., a calcium solid such as calcium oxide or hydroxide), and a salt or brine stream 138. In some embodiments, the salt or brine stream can be sent to the electrolyzer 130 in order to regenerate acid 132 and/or base 134. FIG. 11 also shows a mass balance table for the streams of FIG. 11. This table assumes an iron and/or aluminum feedstock consistent with a natural mafic rock and a decarbonated calcium feedstock consistent with recycled concrete fines.

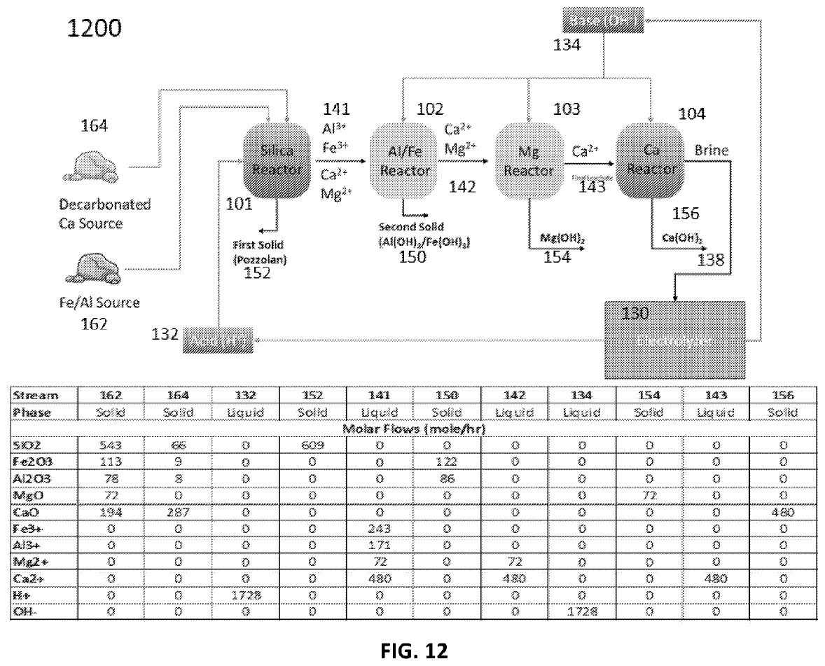

Referring to FIG. 12, a similar process flow is considered similar to FIG. 11, but without the use of the calcium feed sent to the different reactor from the iron and/or aluminum feed.

Referring to FIG. 12, system 1200 may be configured to receive an iron and/or aluminum source 162 and a calcium source 164. In some embodiments, a first reaction chamber 101 can be configured to receive the iron and/or aluminum source 162, the calcium source 164, and an acid 132 (from an electrolyzer 130) such that the iron and/or aluminum source and the calcium source react with the acid to produce product 152 (e.g., a solid pozzolan product) and a first process stream or leachate 141 (which can include iron, aluminum, calcium, and/or magnesium salts or cations). In some embodiments, the product 152 can include silicas, silicates, and/or aluminosilicates. In some embodiments, a second reaction chamber 102 can be configured to receive the first process stream or leachate 141 and a base 134 (from an electrolyzer 130) such that the first process stream or leachate react with the base to produce product 150 (e.g., a solid aluminum and/or iron product that can include aluminum and/or iron oxides or hydroxides) and a second process stream or leachate 142 (which can include calcium and/or magnesium salts or cations). In some embodiments, a third reaction chamber 103 can be configured to receive the second process stream or leachate 142 and a base 134 (from an electrolyzer 130) such that the second process stream or leachate reacts with the base to produce product 154 (e.g., a magnesium solid product such as magnesium oxide or hydroxide) and a third process stream or leachate 143 (which can include calcium salts or cations). In some embodiments, a fourth reaction chamber 104 can be configured to receive the third process stream or leachate 143 and a base 134 (from an electrolyzer 130) such that the third process stream or leachate reacts with the base to produce product 156 (e.g., a calcium solid such as calcium oxide or hydroxide), and a salt or brine stream 138. In some embodiments, the salt or brine stream can be sent to the electrolyzer 130 in order to regenerate acid 132 and/or base 134. As a result of both the iron and/or aluminum feed source and the calcium feed source being sent to the same first reactor than to subsequent reactors as shown in FIG. 11 (and FIG. 2), the molar ratio of calcium to acid decreases from 0.43 (480/1106) to 0.28 (480/1728), as shown in the Table of FIG. 12. Therefore, without the configurations described herein where feed source materials can be routed to different reaction chambers instead of at least two going to the same one, the traditional configuration of the process would require almost twice the acid per mole of calcium hydroxide product. Similarly, the ratio of silicate to acid decreases from 0.49 to 0.35, indicating an approximately 40% increase in acid to produce the silicate solid in stream 156 of FIG. 12 compared to FIG. 11.

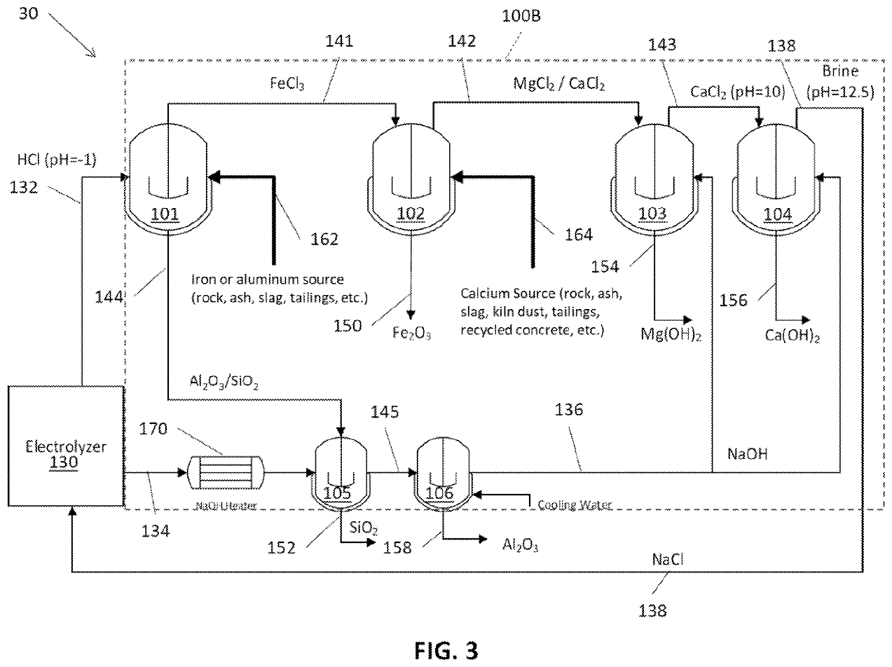

FIG. 3 is a schematic diagram of a dual-feed leaching system 30 and a corresponding leaching method process flow, according to various embodiments of the present disclosure. The system 30 may be similar to the system 20 of FIG. 2. As such, the differences therebetween will be the focus of the following.

Referring to FIG. 3, the system 30 may include a modified reactor system 100B that includes a base heater 170, a fifth reaction chamber 105, and a sixth reaction chamber 106 that are fluidly connected to a base outlet of the electrolyzer 130. The base 134 output from the electrolyzer 130 may be sequentially provided to the heater 170, the fifth reaction chamber 105, and the sixth reaction chamber 106, before being divided between the third reaction chamber 103 and/or the fourth reaction chamber 104, as explained above. In particular, the base heater 170 may be a resistive, inductive, and/or gas-fired heater configured to heat the base 134 before the base 134 is provided to the fifth reaction chamber 105.

In some embodiments, the iron and/or aluminum source feed material 162 may include a significant amount of aluminum, which may be in the form of oxides, salts, and/or hydroxides of aluminum. In some embodiments, a reaction between the iron and/or aluminum source feed material 162 and the acid provided to the first reaction chamber 101 may form a fourth process stream 144 that may be output from the first reaction chamber 101 to the fifth reaction chamber 105. In some embodiments, the fourth process stream 144 may be a solids fraction including acid insoluble silicates and/or aluminosilicates extracted from the iron and/or aluminum source feed material 162.

In some embodiments, the fourth process stream 144 may be provided to the fifth reaction chamber 105 and reacted with the heated base provided from the heater 170. In some embodiments, the reaction may occur at a temperature ranging from about 100° C. to about 300° C., such as from about 150° C. to about 200° C. In some embodiments, most of the insoluble silicates can pass through the reactor to product (e.g., pozzolan product) 152 that may be output from the fifth reaction chamber 105. In some embodiments, the (pozzolan) product 152 may include silicon oxide. In some embodiments, the silicon oxide may be stored in an appropriate container. In some embodiments, a fifth process stream 145 may be generated in the fifth reaction chamber 105 and provided to the sixth reaction chamber 106. In some embodiments, the fifth process stream 145 may include dissolved sodium aluminate (NaAl(OH)₄) recovered from the iron and/or aluminum source feed material 162 provided to the first reaction chamber.

In some embodiments, a fifth process stream 145 comprising the remainder of the fourth process stream 144 and unreacted base may be provided to the sixth reaction chamber 106. In some embodiments, the fifth process stream 145 may be cooled to a temperature ranging from about 100° C. to about 10° C., such as from about 30° C. to about 60° C. For example, cooling water or air may be provided to the sixth reaction chamber 106 to reduce the temperature of the fifth process stream 145 and promote the generation of a product (e.g., aluminum product) 158 and/or release of the base absorbed in reaction chamber 105. In some embodiments, the product 158 may be a solids fraction including precipitated aluminum hydroxide (Al(OH)₃) and/or aluminum oxide (Al₂O₃). In some embodiments, the aluminum product 158 may be stored in a suitable container. In some embodiments, a base stream 136 including unreacted and/or released base generated by the electrolyzer 130 may be provided to the third reaction chamber 103 and/or the fourth reaction chamber 104 for the processes previously described.

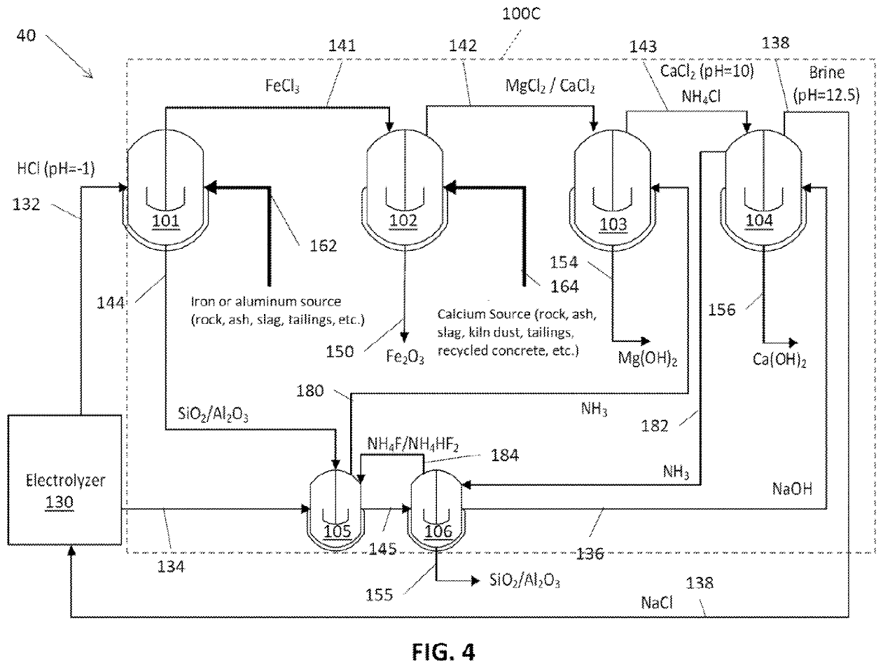

FIG. 4 is a schematic diagram of a dual-feed leaching system 40 and a corresponding leaching method process flow, according to various embodiments of the present disclosure. The system 40 may be similar to the system 30 of FIG. 3. As such, the differences therebetween will be the focus of the following.

Referring to FIG. 4, the system 40 may include a modified reactor system 100C configured to circulate ammonia and/or ammonium salts, such as ammonium fluoride (NH₄F) and ammonium bifluoride (NH₄HF₂), between the third-sixth reaction chambers 103, 104, 105, 106. In some embodiments, a first ammonia stream 180 may be generated in the fifth chamber 105 and output to the third chamber 103. In some embodiments, the ammonia may react with magnesium chloride from the second process stream or leachate 142 to generate the magnesium product 154 output from the third reaction chamber 103. In some embodiments, the magnesium product 154 may include magnesium hydroxide precipitated in the third reaction chamber 103. In some embodiments, the third process stream or leachate 143 may include calcium chloride and/or ammonium chloride, which can react with sodium hydroxide provided to the fourth reaction chamber 104, to form the calcium product 156, the salt or brine stream 138, and/or a second ammonia stream 182.

In some embodiments, the second ammonia stream 182 may be provided from the fourth reaction chamber 104 to the sixth reaction chamber 106. In some embodiments, an ammonium salt stream 184 generated in the sixth reaction chamber 106 may be provided to the fifth reaction chamber 105. Alternatively, instead of passing the ammonia stream to reaction chamber 103 and back from reaction chamber 104, other suitable methods of transferring the ammonia from chamber 105 to 106 at elevated chemical potential can be used, such as using a condenser to liquify the ammonia and then a pump to supply the ammonia as a liquid at elevated pressure or a compressor to directly pressurize the gaseous ammonia. In some embodiments, the ammonium salts may dissolve the silicon oxide and aluminum oxide provided to the fifth chamber 105 by the fourth process stream to generate the fifth process stream 145. The fifth process stream 145 may include dissolved aluminum fluoride and/or dissolved silicon fluoride generated by a dissolving the crystalline silicon oxide and/or aluminum oxide via reactions with the ammonium salts that were provided to the fifth reaction chamber 105 by the ammonium salt stream 184. In some embodiments, the aluminum fluoride and/or silicon fluoride may be reacted with ammonia in the sixth reaction chamber 106 to generate the fifth process stream 145 and an aluminosilicate product 155, which may be output from the sixth reaction chamber 106. In some embodiments, the aluminosilicate product 155 may be a solids fraction including precipitated amorphous silicon oxide, aluminum hydroxide (Al(OH)₃), and/or aluminum oxide (Al₂O₃) generated in the sixth reaction chamber 106. In some embodiments, the amorphous aluminosilicates may provide superior pozzolanic properties, as compared to crystalline silica and alumina.

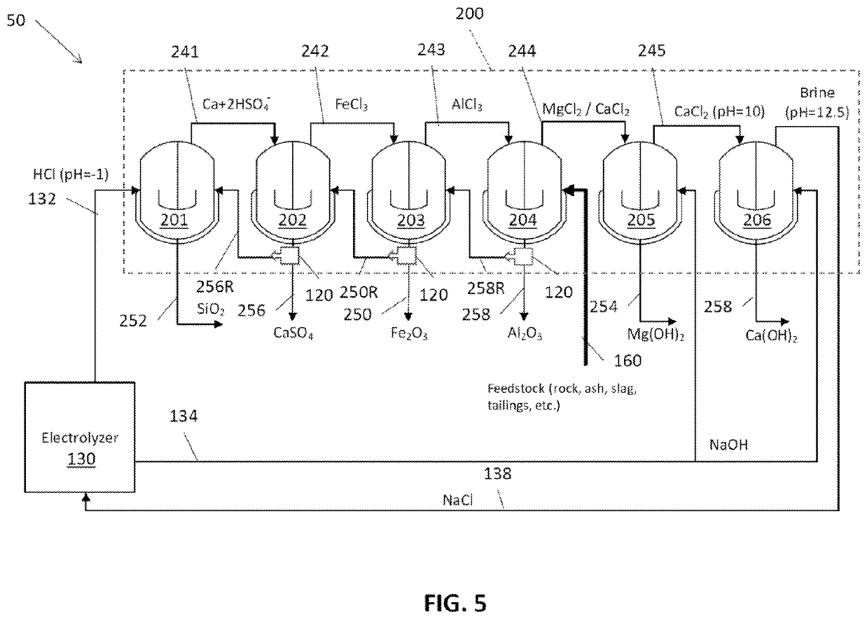

FIG. 5 is a schematic diagram of a single-feed leaching system 50 and a corresponding leaching method process flow, according to various embodiments of the present disclosure. Referring to FIG. 5, the system 50 may include an electrolyzer 130 and a reactor system 200. In some embodiments, the reactor system 200 may include a first reaction chamber 201 (e.g., silica reactor), a second reaction chamber 202 (e.g., calcium reactor), a third reaction chamber 202 (e.g., iron reactor), a fourth reaction chamber 204 (e.g., aluminum reactor), a fifth reaction chamber 205 (e.g., magnesium reactor), and a sixth reaction chamber 206 (e.g., calcium reactor). In some embodiments, the electrolyzer 130 may be configured to provide an acid 132 to the first chamber 201 and a base 134 to the sixth chamber 206. In some embodiments, a salt or brine stream 138 output from the sixth reaction chamber 206 may be provided to the electrolyzer 130 (for regenerating the acid and/or base).

In some embodiments, a feed material 160 as described above may be provided to the fourth reaction chamber 204. In some embodiments, a third process stream 243 output from the third chamber 203 may also be provided to the fourth chamber 204 and mixed with the feed material 160. In some embodiments, the third process stream 243 may include aluminum chloride generated in the third chamber 203.

In some embodiments, an aluminum product 258 may be a solids fraction generated in the fourth chamber 204. In some embodiments, the aluminum product 258 may include precipitated aluminum hydroxide (Al(OH)₃) and/or aluminum oxide (Al₂O₃) generated by a reaction between aluminum chloride and a base such as sodium chloride. In some embodiments, an aluminum recycle stream 258R may be separated from the aluminum product 258 by a separation device 120 and recycled to the third chamber 203.

In some embodiments, an iron product 250 may be a solids fraction generated in the third chamber 203. In some embodiments, the iron product 250 may include precipitated iron oxide. In some embodiments, an iron recycle stream 250R may be separated from the iron product 250 by a separation device 120 and recycled to the second chamber 202.

In some embodiments, a calcium product 256 may be a solids fraction generated in the second chamber 202. The calcium product 256 may include precipitated calcium sulfate (CaSO₄). In some embodiments, a calcium recycle stream 256R may be separated from the calcium product 256 by a separation device 120 and recycled to the first chamber 201.

In some embodiments, a silicon product 252 may be a solids fraction generated in the first chamber 201. In some embodiments, the silicon product 252 may include insoluble silicas (e.g., silicon oxide), silicates, and/or aluminosilicates In some embodiments, the calcium sulfate may react with the acid provided to the first chamber 201 to generate dissolved calcium ions, singly protonated bisulfate (HSO₄⁻) ions, and chloride ions within a first process stream 241 that is output to the second chamber 202. The first process stream 241 may be a liquid fraction including calcium ions (Ca⁺), bisulfate ions (HSO₄⁻), chloride ions, and/or remaining hydrochloric acid.

In some embodiments, in the second chamber 202, the bisulfate ions and chloride ions from the first process stream 241 react with the iron oxides entering through the iron recycle stream 250R to form iron trichloride. In some embodiments, a second process stream 242 may be output from the second chamber 202 to the third chamber 203. In some embodiments, the second process stream 242 may be a liquid fraction including iron trichloride generated in the second chamber 202 by a reaction between the hydrochloric acid and the iron oxide.

In some embodiments, in the third chamber 203, the chloride ions entering from the second process stream 242 react with the aluminum oxides entering through the recycle stream 258R to form aluminum trichloride. In some embodiments, a third process stream 243 may be output from the third chamber 203 to the fourth chamber 204. In some embodiments, the third process stream 243 may be a liquid fraction including aluminum chloride generated in the third chamber 203 by a reaction between the iron trichloride and the aluminum oxide.

In some embodiments, a fourth process stream 244 may be output from the fourth chamber 244 to the fifth chamber 205. In some embodiments, the fourth process stream 244 may be a liquid fraction including dissolved magnesium chloride and calcium chloride generated in the fourth chamber 204 by a reaction between the magnesium and calcium oxides and the aluminum chloride.

In some embodiments, a magnesium product 254 may be output from the fifth chamber. In some embodiments, the magnesium product 254 may be a solids fraction including precipitated magnesium hydroxide generated by a reaction between the magnesium chloride and the base (e.g., sodium hydroxide) generated by the electrolyzer 130. In some embodiments, a fifth process stream 245 may be output from the fifth chamber 205 to the sixth chamber 206. In some embodiments, the fifth process stream 245 may be a liquid fraction including calcium chloride.

In some embodiments, a precipitated calcium product 258 may be output from the sixth chamber 206. In some embodiments, the calcium product 258 may be a solids fraction including calcium hydroxide generated by a reaction between the calcium chloride and the base (e.g., sodium hydroxide) provided by the electrolyzer 130.

In some embodiments, the recycle streams 258R, 250R, and 256R of each product stream are respectively recycled back to the higher acidity chambers 203, 202, 201. In some embodiments, the separation devices 120 may be a tee or wye standard pipe fitting. In some embodiments, the separation devices 120 may be a hydrocyclone, elutriation tank, or centrifuge, in order to selectively recycle components based on particle size and/or a density.

In some embodiments, the pH within each of the chambers 201, 202, 203, 204, 205, 206, may be controlled in order to selectively promote the formation of the corresponding products 250, 252, 254, 256, 258. For example, the first chamber 201 may have the lowest pH, the second-sixth chambers 202, 203, 204, 205, 206, may have progressively higher pH's. The pH's for chambers 202, 203, 204, 205, and 206 may be kept near the pKa's of the respective acids being reacted. In some embodiments, chambers 202, 203, and 204 may respectively have pH's maintained around the pKa's of bisulfate (approximately pH 1-2), iron (III) chloride (approximately pH 2-3), and aluminum (III) chloride (approximately pH 4-5). In some embodiments, the pH for reactors 205 and 206 may respectively be maintained around the pKa's of magnesium hydroxide (10-12) and calcium hydroxide (12-13), respectively.

In some embodiments, amounts of the base provided to the fifth chamber 205 and the sixth chamber 206 may be controlled such that a higher pH is maintained in the sixth chamber than in the fifth chamber 205. Accordingly, the relatively lower pH of the fifth chamber 205 may promote the formation of magnesium hydroxide, and the relatively higher pH of the sixth chamber 206 may promote the formation of calcium hydroxide.

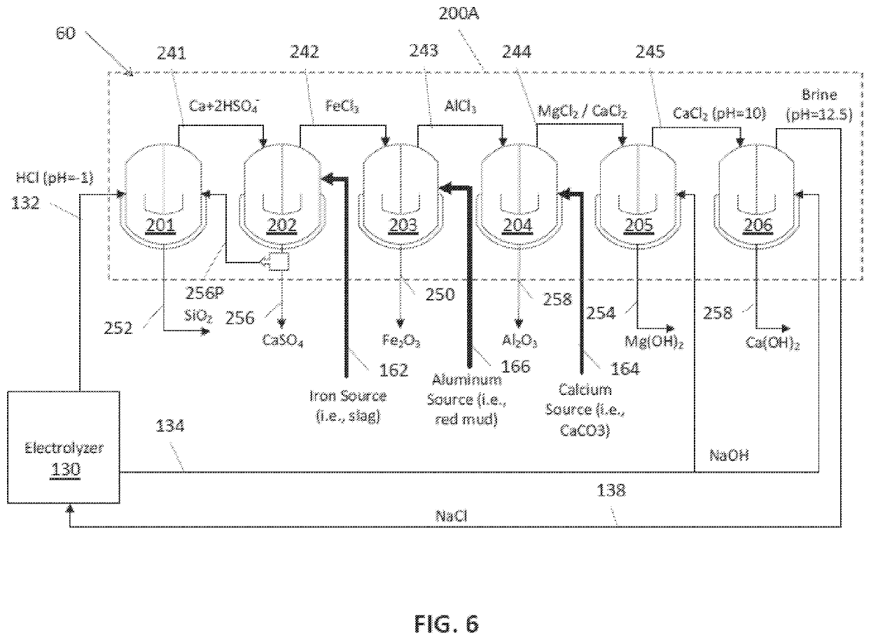

FIG. 6 is a schematic diagram of a multi-feed leaching system 60 and a corresponding process flow, according to various embodiments of the present disclosure. The system 60 may be similar to the system 50 of FIG. 5. As such, the differences therebetween will be the focus of the following.

Referring to FIG. 6, the system 60 may include a modified reactor system 200A configured to process an iron source feed material 162, a calcium source feed material 164, and an aluminum source feed material 166. In some embodiments, the iron source feed material 162 may be supplied to the second chamber 202, the aluminum source feed material 166 may be supplied directly to the third chamber 203, and a calcium source feed material 164 may be supplied directly to the fourth chamber 204. In some embodiments, the aluminum source feed material 166 may include a relatively high aluminum content, as compared to the iron source feed material 162 and the calcium source feed material 164. In some embodiments, the aluminum source feed material 166 may be red mud or the like. The various reactions as described in FIG. 5 can take place in FIG. 6 except that there are additional feeds to the various reactors.

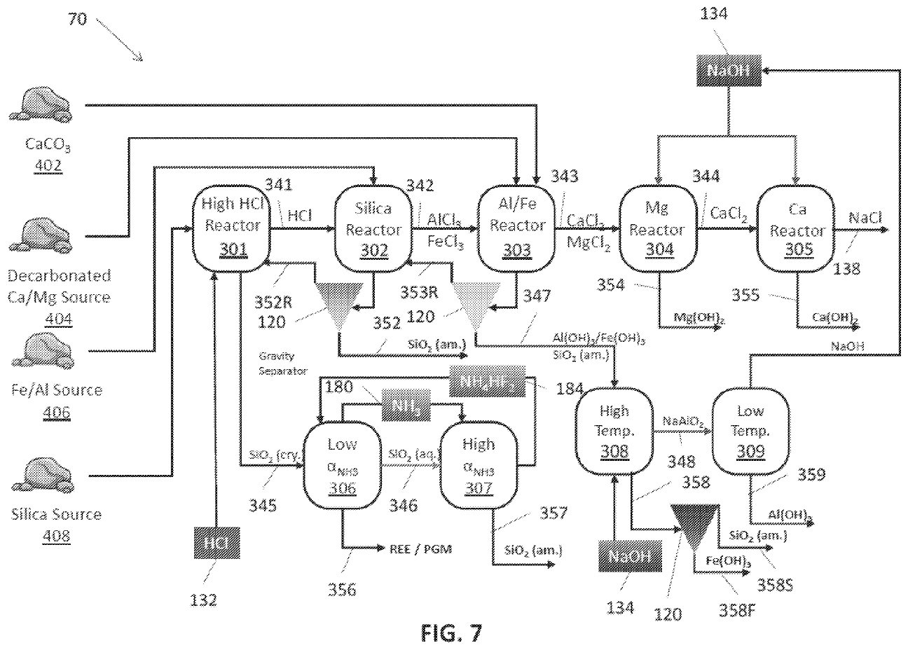

FIG. 7 is a schematic diagram of a multi-feed leaching system including multiple purification systems and a corresponding process flow, according to various embodiments of the present disclosure. The system 70 may be similar to the system 60 of FIG. 6. As such, the differences therebetween will be the focus of the following.

Referring to FIG. 7, the system 70 may be configured to receive a CaCO₃ source feed material 402, a decarbonated Ca/Mg source feed material 404, an Fe/Al source feed material 406, a silica source feed material 408, a acid 132, and/or a base 134.

In some embodiments, the system 70 may include a first reaction chamber 301 (e.g., high acid reactor), a second reaction chamber 302 (e.g., silicon reactor), a third reaction chamber 303 (e.g., aluminum reactor), a fourth reaction chamber 304 (e.g., magnesium reactor), a fifth reaction chamber 305 (e.g., calcium reactor), a sixth reaction chamber 306 (e.g., low ammonia reactor), a seventh reaction chamber 307 (e.g., high ammonia reactor), an eight reaction chamber 308 (e.g., high temperature reactor), and/or a ninth reaction chamber 309 (e.g., low temperature reactor).

In some embodiments, the first chamber 301 may be configured to receive the acid 132, the silica source feed material 408, and a silica recycle stream 352, and may be configured to output a first process stream 341 and a fifth process stream 345. In some embodiments, the first process stream 341 may include unreacted acid 132, and the fifth process stream 345 may include crystalline silica. In some embodiments, the first chamber 301 may operate to pre-leach silica included in the fifth process stream 345 and/or process a fraction of other solids exiting the first chamber 301.

In some embodiments, the second chamber 302 may be configured to receive the first process stream 341, the iron/aluminum source feed material 406, and an Al/Fe/Si recycle stream 353R and may be configured to output a second process stream 342 and an amorphous silica product 352. In some embodiments, a separation device 320 may be configured to form the silica recycle stream 352 by diverting a portion of the amorphous silica product 352.

In some embodiments, the third chamber 303 may be configured to receive the second process stream 342, the CaCO₃ source feed material 402, and the decarbonated Ca/Mg source feed material 404 and may be configured to output a third process stream 343 and a seventh process stream 347. In some embodiments, the third process stream 343 may include alkaline earth metal salts, such as CaCl₂ and MgCl₂. In some embodiments, a separation device 320 may be configured to form the Al/Fe/Si recycle stream 353R by diverting a portion of the seventh process stream 347. In some embodiments, the seventh process stream 347 may include amorphous silica, iron hydroxide, aluminum hydroxide, and/or aluminum oxide.

In some embodiments, the fourth chamber 304 may be configured to receive the third process stream 343 and the base 134 and may be configured to output a fourth process stream 344 and a Mg product 354. In some embodiments, the Mg product 354 may include magnesium hydroxide and the fourth process stream 344 may include calcium chloride.

In some embodiments, the fifth chamber 305 may be configured to receive the fourth process stream 344 and the base 134 and may be configured to output a brine stream 138 and a Ca product 354. In some embodiments, the Ca product 354 may include calcium hydroxide.

In some embodiments, the sixth chamber 306 may be configured to receive the fifth process stream 345 and an ammonium salt steam 184 generated in the seventh chamber 106 and may be configured to output a sixth process stream 346, ammonia 180, and a rare earth element (REE) and/or platinum group metal (PGM product 356. In some embodiments, the sixth process stream may include aqueous silica.

In some embodiments, the seventh chamber 307 may be configured to receive the ammonia 180 and the sixth process stream 346 and may be configured to output the ammonium salt steam 184 and an amorphous silica product 357. In some embodiments, the system 70 may be configured such that the seventh chamber 307 has a lower pressure and/or temperature than the sixth chamber 306, such that the ammonia 180 is condensed in the sixth chamber 306 and then provided to the seventh chamber 307.

In some embodiments, the eight chamber 308 may be configured to receive the base 134 and the seventh process stream 347 and may be configured to output a Si/Fe product 358 and an eighth process stream 348. In some embodiments, the eighth process stream 348 may include alumina salts, such as NaAlO₂. In some embodiments, the Si/Fe product 358 may include iron hydroxide and amorphous silica. In some embodiments, the Si/Fe product 358 may be provided to a separation device 120, such as a gravity or centrifugal separator, configured to separate iron oxide product 358F and an amorphous silica product 358S from the Si/Fe product 358.

In some embodiments, the ninth chamber 309 may be configured to receive the eighth process stream 348 and the base 134 and output an aluminum oxide and/or aluminum hydroxide product 359 and the base 134. In some embodiments, the system 70 may be configured to maintain the nineth chamber 309 at a lower temperature than the eight chamber 308, in order to promote the generation of the Si/Fe product 358 in the eighth chamber 308 and the generation of the aluminum oxide and/or aluminum hydroxide product 359 in the nineth chamber 309. For example, the base 134 may be heated to prior to being provided to the eighth chamber 308 and/or the eighth chamber 308 may be directly heated, to ensure that the compounds in the eighth chamber 308 are heated to a desired reaction temperature that promotes the formation of the Si/Fe product 358.

In some embodiments, particular solids produced by the systems and methods disclosed herein can be combined to form a cementitious material. For example, one or more of the solids from first product (e.g., product 152), second product (e.g., product 150), third product (e.g., product 154), and fourth product (e.g., product 156) can be combined to form a cementitious material. In some embodiments, particular solids such as those containing the silicates, aluminosilicates, aluminum oxides and/or hydroxides, iron oxide and/or hydroxides, and/or calcium oxides or hydroxides may be combined and/or reacted together to form a cementitious material. In some embodiments, particular solids such as those containing the silicates, aluminosilicates, aluminum oxides and/or hydroxides, iron oxide and/or hydroxides, and/or calcium oxides or hydroxides may be further treated (e.g., heated) in a kiln to form cementitious materials. In some embodiments, cementitious materials include, but are not limited to, ordinary portland cement, belite and belite-derived cements, calcium aluminate cements, and calcium sulfoaluminate cements.

In some embodiments, additives including limestone, basalt powder, sulfate sources (e.g., gypsum, anhydrite, calcium sulfate hemihydrate), portland cement, calcium aluminate cement, calcium sulfoaluminate cement, and others can be combined with one or more of the solid products to form cements or cementitious materials with beneficial properties including lower global warming potential, greater compressive strength, greater durability, greater resistance to sulfate attack, greater resistance to the alkali silica reaction (ASR), lighter color, and/or lower cost.

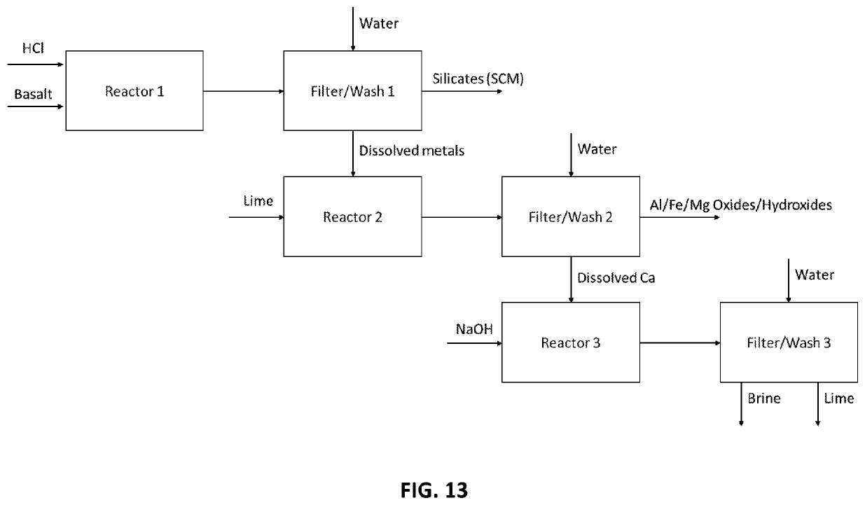

FIG. 13 illustrates a series of experimental processes that were performed in order to demonstrates the feasibility of the methods and systems disclosed herein. As shown in FIG. 13, a sample of basalt rock was ground and leached in hydrochloric acid. The mixture was then filtered and washed using vacuum filtration to generate a pozzolanic solid (the SCM) and a leachate stream with dissolved solids (e.g., metals). The dissolved solids were then reacted with a high calcium precipitating agent (hydrated lime), which precipitated the iron, aluminum, and magnesium cations in the form of oxides and/or hydroxides. The mixture was then filtered and washed using vacuum filtration to generate an oxide/hydroxide solid cake and calcium-rich solution. The calcium-rich solution was then reacted with sodium hydroxide to form a precipitated hydrated lime with advantageous properties for use in cement blends. The precipitated solid was separated from the resultant brine using vacuum filtration. A table of the elemental concentrations of several cations measured by inductively-coupled plasma optical emissions spectroscopy (ICP-OES) from the process shown in FIG. 13 is shown below. As shown in the table, the solution between Reactor 1 and 2 contains a mix of aluminum, iron, magnesium, and calcium (the amount of calcium is elevated because the basalt was conveyed into the reactor in a slurry containing calcium chloride). After the addition of lime, the calcium increases further by 2.7% while the total concentration of aluminum, iron, and magnesium drops to less than 0.1% due to the precipitation of respective hydroxides and oxides. After the addition of sodium hydroxide (NaOH), the calcium is precipitated to calcium hydroxide solid and the brine concentrations drop to below 0.01% with neither iron nor magnesium detectable by the instrument.

### Stream Compositions Shown in FIG. 13

| | Dissolved | Dissolved | |
|---|---|---|---|
| Element | Metals | Ca | Brine |
| Al | 0.340% | 0.01% | 0.0001% |
| Ca | 11.9% | 14.6% | 0.004% |
| Fe | 1.00% | 0.03% | ND |
| Mg | 0.330% | 0.0003% | ND |
| Na | 0.02% | 0.03% | 9.50% |

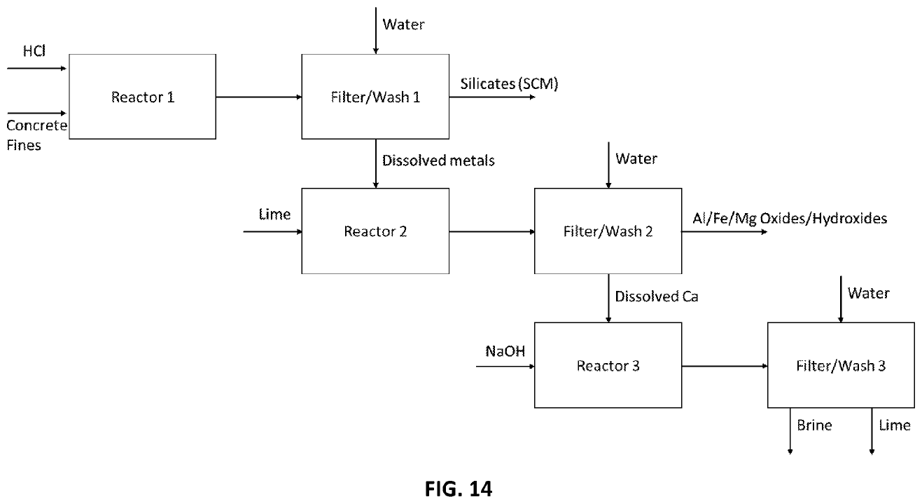

FIG. 14 illustrates a series of experimental processes that were performed in order to demonstrates the feasibility of the methods and systems disclosed herein. As shown in FIG. 14, a sample of concrete fines from a returned concrete pond was provided by a concrete plant. The fines were leached in hydrochloric acid. The mixture was then filtered and washed using vacuum filtration to generate a pozzolanic solid (the SCM) and a leachate stream with dissolved solids. The dissolved solids were then reacted with a high calcium precipitating agent (hydrated lime), which precipitated the iron, aluminum, and magnesium cations in the form of oxides and/or hydroxides. The mixture was then filtered and washed using vacuum filtration to generate an oxide/hydroxide solid cake and calcium-rich solution. That solution was then reacted with sodium hydroxide to form a precipitated hydrated lime with advantageous properties for use in cement blends. The precipitated solid was separated from the resultant brine using vacuum filtration.

Various embodiments may be configured to provide appropriate residence times, pH controls, and/or recycle loops, in order to significantly reduce acid consumption while generating multiple concentrated precipitated products (e.g., silicates, aluminum hydroxide, iron oxides, etc.) In some embodiments, the concentrated component streams may be further purified in order to produce saleable products and/or to produce products that may be blended into construction materials such as cement and/or concrete. Additionally, alkaline metals, such as magnesium and/or calcium, can be extracted via precipitation through the addition of base such as hydroxide and/or ammonia solutions or heated to decompose the metal salts into metal oxides. In some embodiments, iron species may be extracted in oxide or hydroxide forms suitable for iron ores or pigments.

In some embodiments, feedstocks, intermediate streams, and product streams may undergo comminution processes such as grinding or crushing. Further, these streams may undergo size and/or density classification processes through hydrodynamic or gravity-based means to separate out different materials and/or particle sizes. In some embodiments, two materials may be fed into a reactor or reactor system with different particle sizes to facilitate their separation upon exiting the reactor or reactor system. In some embodiments, one or more of the reactors may be such that they serve as both a reactor and simultaneously comminute the material within.

In some embodiments, an advantage of the counter-current and/or cross-current leaching system is that the intermediate reactors can possess a more neutral pH greater than 0 and preferably greater than 1. The more neutral pH can allow for greater flexibility in material selection when designing reactors and/or adding features such as sensors, impellers, and crushing or grinding mechanisms.

After the acid leaching system, various purification steps may include dissolution and precipitation of components using solvents such as concentrated base or a fluoride salt such as ammonium fluoride, ammonium bifluoride, hydrofluoric acid, sodium fluoride, potassium fluoride, and/or potassium bifluoride, for example as described in PCT/US2023/062144 which is incorporated herein in its entirety by reference. Such purifications can serve to both isolate individual chemical constituents as pure products, increasing their sale value and chemically transform their crystal structure and/or morphology to increase their reactivity, flowability, and/or economic value. For example, amorphous silicates, aluminosilicates, and/or aluminum hydroxides can be more reactive pozzolans than their corresponding crystalline forms. Powders with more spherical morphologies can be more flowable and require the addition of less water when blended into cement, which can increase the cement strength.

When using a concentrated base, aluminum hydroxide can be separated from iron and/or silica through high temperature dissolution, removal of the remaining solids, and/or subsequent cooling and precipitation of the aluminum hydroxide. If silica is present along with iron oxides and/or aluminum hydroxide, the silica can be separate from the iron oxides via a gravity-based method due to the higher density of iron compounds. Introduction of different components into the reactor system with differing particle size may assist this separation. In some embodiments, such as use in cement concrete, iron and/or aluminum may not be separated and used as a combined additive.

When using fluoride-based salts, leaching of the silica and/or aluminosilicate material prior to digestion with the fluoride reagent can be advantageous to prevent the formation of insoluble fluoride salts such as calcium fluoride and/or magnesium fluoride if calcium and/or magnesium are present in the feedstock material. Further, leaching of the silica and/or aluminosilicate feedstock can increase the surface area of the material increasing its dissolution rate during the fluoride dissolution. The presence of residual acid from the leaching process can support the fluoride-based dissolution of the silicates.

A purpose of the fluoride dissolution and precipitation can be to generate silicates and/or aluminosilicates with high amorphous content and appropriate morphology to generate a powder with a combination of high reactivity and good wet flowability for use as a pozzolan material in cement. The precipitation of the silicates and/or aluminosilicates can be controlled through maintaining particular temperatures and ammonia concentrations to achieve and maintain desired levels of supersaturation during precipitation. Further adjustments to the morphology of the particles can be achieved through control of the intensity of mixing, the use of seeding, and/or through continuous particle separation via means such as an elutriation tank or other hydrodynamic or gravity-based separator.

In some cases, it may be preferable to perform the precipitation using two vessels with the first held at conditions to facilitate the appropriate rate of nucleation and the second held at different conditions to facilitate particle growth.

A second benefit of the fluoride-based dissolution and precipitation step can be to release rare earth elements (REEs) and other high value noble metals, such as platinum group metals (PGMs). Such valuable metals may be bound in the silicate fractions of the minerals and unable to be extracted without dissolution of the silicate portion. As REEs and PGMs will be insoluble in the fluoride leaching solution, they can be recovered as solids from the dissolution reactor.

In some embodiments, it may be preferable to mix two or more pozzolans with different properties—at least one with high specific surface area and at least one with good flow properties—to create an ideal pozzolan mixture for cement blending. Such a mixture can be accommodated by adjusting the ratio of solids recycle throughout the systems leaching and purification reactors and control of the ratio of different silicate and/or aluminosilicate containing feedstocks.

### Decarbonization of Concrete and Cement

The cement industry has established methods for reducing clinker use. Currently, the most prevalent method is to replace a portion of clinker with supplementary cementitious materials (SCMs). SCMs can include amorphous silica that pozzolanically reacts with a calcium hydroxide byproduct formed by clinker hydration. This pozzolanic reaction can produce calcium silicate hydrate, which is the same hardened phase responsible for the strength and durability of conventional Portland cement. SCM use has decreased over the past few years due to a decline in global synthetic SCM production (fly ash and blast furnace slag). Accordingly, there is a need for a low-CO₂ process capable of producing SCM-grade, pozzolanic silica from abundant, non-pozzolanic silica to fill this market gap. As described above, the process can produce SCM materials through acid leaching of abundant feedstocks. Additional processing steps can further improve those SCMs to increase their value. Further, these methods can increase the range of materials that can be processed into saleable SCMs.

Disclosed herein is also a family of low-CO₂, low-temperature methodologies for the conversion of non-pozzolanic silica into pozzolanic silica. In some embodiments, the first solid products (for example, product 152, 155, 252, 352) can produce silicon containing solids that may be non-pozzolanic or crystalline. These non-pozzolanic or crystalline silicon containing solids can be used in the following processes to create amorphous, pozzolanic silicon containing solids. The process technology can be centered on the low-temperature dissolution of crystalline, non-pozzolanic silica sources with re-precipitation of amorphous, pozzolanic silica. This technology may beneficially mitigate greenhouse gas (GHG) emissions from the cement industry, while simultaneously providing a supply of SCMs for ready-mix concrete producers. This technology may also be used in conjunction with other electrochemical decarbonization technology to manufacture low-CO₂ hydraulic cement, such as Sublime Cement™, with the potential for a >90% reduction in GHG emissions relative to traditional routes of Portland cement production.

Methodologies for modifying silicate minerals are provided in accordance with various embodiments. All the processes discussed below may have the ability to generate amorphous silicate but have not been previously adapted for SCM production.

In some embodiments, a methodology for modifying silicate minerals in accordance with various embodiments may include a process for acid-base precipitation. The methodology may include preparation of amorphous silica through dissolution of silica in base followed by precipitation with acid. This process, however, has not been deployed for SCM or cement production and would be uneconomical using high-value acids (typically sulfuric acid) and bases (typically sodium hydroxide). In some embodiments, adapting acid-base precipitation for SCM production may require the replacement of one or both of the high-value acids or bases with lower energy alternatives.

In some embodiments, a methodology for modifying silicate minerals in accordance with various embodiments may include a process including ammonium bifluoride dissolution and precipitation. In some embodiments, ammonium bifluoride is a commercially available HF-free glass etchant (i.e., it dissolves silica), it may be used for purifying silica for the semiconductor industry through dissolution and precipitation cycles. Adapting the ammonium bifluoride silica purification method for SCM production may include optimizing the operating conditions to generate amorphous silica with the ideal precipitate morphologies at conditions appropriate for large-scale commodity production.

In some embodiments, a methodology for modifying silicate minerals in accordance with various embodiments may include a process leveraging temperature swings. Aluminum hydroxide (Al(OH)₃) bearing silicate minerals such as bauxite may be processed using the Bayer process, which involves dissolving the minerals in sodium hydroxide at elevated temperature to selectively dissolve the Al(OH)₃ from the remaining mineral. The dissolved Al(OH)₃ may then be precipitated separately through temperature reduction. In some embodiments, the residual depleted mineral, known as red mud, is then discarded and has led to significant environmental challenges. A no-waste version of the Bayer process may be adapted for production of SCM from aluminum-bearing silicate rocks.

Various embodiments may have impacts on: i) silicate performance as shown by silicate performance testing, such as pozzolanic reactivity, water demand, cement mortar and concrete strength, setting time, flow, durability, and other required properties as specified in relevant standards; ii) technoeconomic performance as shown by technoeconomic analysis, such as raw materials cost, availability, transportation, transformation efficiency, projected process capital and operating costs; and/or, iii) lifecycle performance as shown by lifecycle assessment, such as process performance relative to lowest achievable emissions.

Various embodiments may provide: i) industrially-relevant process equipment capable of achieving cement industry scale (millions of tonnes per year) for each key step in the process; ii) detailed mass and energy balance for both pilot scale and commercial scale; and/or, iii) a commercial scale technoeconomic model consistent with a Front-End Loading 2 (FEL-2) level of engineering.

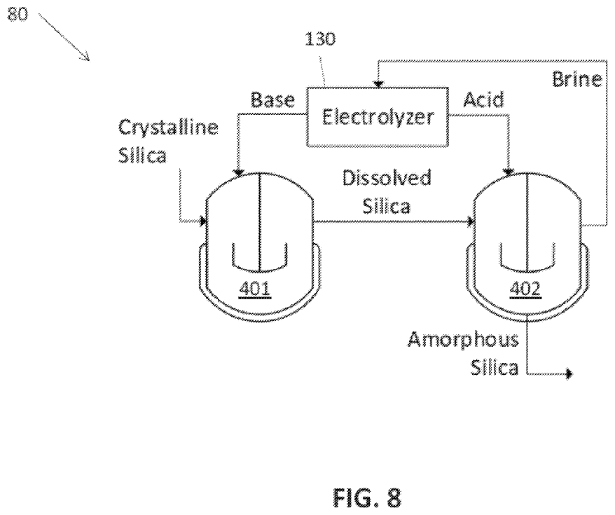

FIG. 8 is a schematic diagram of an acid/base silica modification system 80, according to various embodiments of the present disclosure. Referring to FIG. 8, the system 80 may include a first reaction chamber 401 (e.g., silica dissolution reactor), a second reaction chamber 402 (e.g., amorphous silica precipitation reactor), and an electrolyzer 130. In some embodiments, the first reaction chamber 401 may be configured to receive crystalline silica and a base generated by the electrolyzer 130. In some embodiments, the crystalline silica may be dissolved by the base and dissolved silica may be output to the second reaction chamber 402. In some embodiments, an acid generated by the electrolyzer 130 may be provided to the second reaction chamber 402 to precipitate amorphous silica and generate brine. In some embodiments, the amorphous silica may be collected in a container as an SCM, which may be used to form cement or concrete in a subsequent manufacturing process.

In some embodiments, the system 80 may be operated using relatively high-value acids (e.g., sulfuric acid) and bases (e.g., sodium hydroxide). However, in embodiments where the amorphous silica is utilized as an SMC for cement production, the use of such high-value acids and bases may render the process uneconomical. As such, one or both of the standard acids or bases may be replaced with lower energy alternatives.

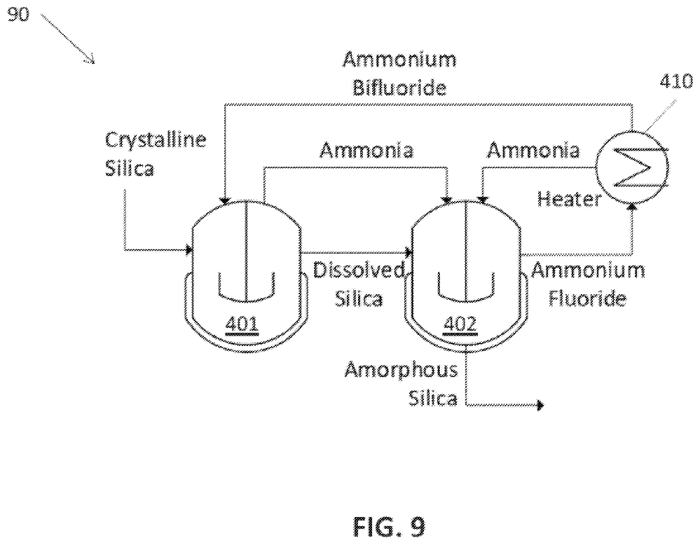

FIG. 9 is a schematic diagram of an aluminum bifluoride cycle silica modification system 90, according to various embodiments of the present disclosure. Referring to FIG. 9, the system 90 may include a first reaction chamber 401 (e.g., silica dissolution reactor), a second reaction chamber 402 (e.g., amorphous silica precipitation reactor), and a heater 410. The first reaction chamber 410 may be configured to receive crystalline silica and ammonium bifluoride.

Ammonium bifluoride is a commercially available HF-free glass etchant that may be utilized to dissolve the crystalline silica, and the dissolved silica and ammonia generated in the first reaction chamber 401 may be provided to the second reaction chamber 402. Heated ammonia may also be provided to the second reaction chamber 401 to precipitate amorphous silica, which may be stored in a container. In some embodiments, ammonia fluoride generated in the second reaction chamber 402 may be heated in the heater to generate ammonia and ammonia bifluoride. In some embodiments, the operating conditions of the system 90 may be configured to generate amorphous silica having precipitate morphologies at reaction conditions appropriate for large-scale commodity production.

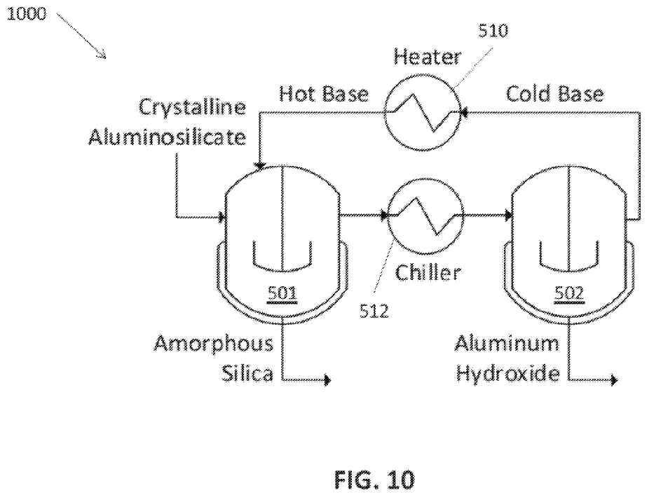

FIG. 10 is a schematic diagram of a thermal swing aluminosilicate modification system 1000, according to various embodiments of the present disclosure. Referring to FIG. 10, the system 1000 may include a first reaction chamber 501 (e.g., amorphous silica precipitation reactor), a second reaction chamber 502 (e.g., aluminum hydroxide (Al(OH)₃) precipitation reactor), a heater 510, and a chiller 512.

In some embodiments, the first reaction chamber 501 may be configured to receive a crystalline aluminosilicate bearing material, such as aluminum-bearing silicate rocks and a heated base, such as sodium hydroxide or the like, output from the heater 510. In some embodiments, amorphous silica may be precipitated in the first reaction chamber 501 and collected in a storage vessel. In some embodiments, a liquid fraction including a remaining amount of the heated base and aluminum compounds may be output from the first reaction chamber 510, cooled in the chiller, and provided to the second reaction chamber 502.

In some embodiments, aluminum hydroxide may be precipitated in the second reaction chamber and collected in a storage vessel. In some embodiments, the aluminum hydroxide precipitation may be promoted by the temperature reduction imparted by the chiller 512. In some embodiments, a liquid fraction including the cooled base may be provided to the heater 510. Accordingly, the system 1000 may generate amorphous silica, without generating a depleted waste material, such as red mud, which is generated in prior processes.

In some embodiments, the systems 80, 90, 1000 may be configured to use variable source materials to generate SCMs having a high consistency, a high degree of pozzolanic reactivity, and a broad availability. As such, the systems 80, 90, 1000 may be configured to generate SCMs that satisfy the requirements of cement manufactures for forming a high-consistency final product. In addition, the synthetic pozzolans generated by various embodiments may result in significant reduction in carbon dioxide emission, as compared to conventional SCM production methods. For example, utilizing the disclosed systems and methods to generate synthetic SCMs, in conjunction with low-CO₂ cement manufacturing processes, such as Sublime Cement™ formulations, CO₂ emissions may be reduced by 90% or more, as compared to conventional processes.

Cement may be benchmarked against standard cement formulations for both mechanical properties (e.g., compressive strength, durability) and chemical properties (e.g., set time). ASTM-C1157 and ACI 318 may function as acceptance thresholds. Cement formulations exceeding these thresholds may be compared against state-of-the-art global warming potential (GWP) performance targets established by The National Ready Mix Concrete Association for concrete blends containing various ratios of fly ash and slag as a proportion of volume.

The following Table 1 illustrates the current performance of Sublime Cement™ and projected commercial performance using ground natural pozzolan as the silica source.

TABLE 1

| | | | Current | | | |
|---|---|---|---|---|---|---|
| | | | (October | | Projected | |
| PARAMETER | TARGET | | 2022) | | Commercial | |
| Compressive strength, 3 days | ≥13 | MPa | 19.0 ± 0.7 | MPa | ≥13 | MPa |
| Compressive strength, 7 days | ≥20 | MPa | 30.4 ± 1.7 | MPa | ≥20 | MPa |
| Compressive strength, 28 days | ≥28 | MPa | 44.2 ± 2.1 | MPa | ≥28 | MPa |

| Time of setting, initial | ≥45 min. ≤7 | 2.2 | hr | ≥45 min. ≤7 |
|---|---|---|---|---|
| | hr | | | hr |
| Mortar bar expansion under water, 14 days | ≤0.020% | 0.01% | | ≤0.020% |
| Air content of mortar | ≤12% | 6.6% | | ≤12% |
| Autoclave length change | ≤+0.80% | −0.04% | | ≤±0.80% |
| Projected CO₂ intensity at scale | | 0.38 | kg CO₂/kg | <0.09 kg |

| | | |
|---|---|---|
| | | CO₂/kg |
| Clinker factor (mass fraction of cement) | 0.357 | 0.000 |

The silica resulting from embodiment processes disclosed herein may have high pozzolanic reactivity (e.g., 100 g Ca(OH)₂ consumed per 100 g SiO₂ at 50° C. after 10 days) and cement cast using this silica may have sufficient flow (equal to or larger than 100% portland cement control). In some embodiments, cement formulations require high consistency in the final product. Various embodiments discussed herein may take limited and variable SCM sources and convert them into a material with a higher degree of pozzolanic reactivity, greater consistency, and broader availability. Moreover, various embodiments may enable the use of local silica sources, lowering the transportation costs involved with SCM usage.

In some embodiments, the products generated by the above systems and methods may be used in various applications and/or subjected to further processing and/or purification. For example, calcium hydroxide and amorphous aluminosilicates may be used as components for the manufacture of construction materials such as cement and/or concrete, without the need for calcium carbonate, which may reduce environmental impacts. In addition, by generating separate products, the present systems and methods may provide increased value and product applications.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that the fraction of the weak acid present in its conjugate base form may be less than about 100%, about 90%, or about 80% is meant to mean that the fraction of the weak acid present in its conjugate base from may be less than about 100%, less than about 90%, or less than about 80%.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
reacting a first feed material comprising iron and/or aluminum with an acid to produce a first leachate comprising iron and/or aluminum cations;
reacting the first leachate with a second feed material comprising calcium to produce a second leachate comprising calcium cations and a solid comprising iron and/or aluminum oxides or hydroxides;
reacting at least a portion of the second leachate to form a calcium oxide or hydroxide; and
regenerating the acid.

2. The method of claim 1, wherein the first feed material comprises a natural rock or mineral comprising basalt, gabbro, amphibolite, feldspar, pyroxene, anorthosite, anorsite, or combinations thereof.

3. The method of any one of claims 1-2, wherein the first feed material comprises iron oxide and/or aluminum oxide concentrations greater than 10 wt. % as measured by X-ray Fluorescence (XRF).

4. The method of any one of claims 1-3, wherein the second feed material comprises a calcium oxide concentration greater than 20 wt. % as measured by XRF.

5. The method of any one of claims 1-4, wherein the second feed material comprise an industrial byproduct comprising ash, kiln dust, slag, recycled concrete, or a combination thereof.

6. The method of any one of claims 1-5, wherein reacting the first feed material with the acid produces a second solid comprising a pozzolanic material.

7. The method of claim 6, wherein the pozzolanic material has a strength activity index of greater than 75% at 7 and 28 days.

8. The method of any one of claims 1-7, wherein the acid comprises an inorganic acid.

9. The method of claim 8, wherein the inorganic acid comprises hydrochloric acid.

10. The method of any one of claims 1-9, wherein the acid comprises an organic acid.

11. The method of claim 10, wherein the organic acid comprises acetic acid.

12. The method of any one of claims 1-11, wherein the acid is regenerated using electrolysis.

13. The method of any one of claims 1-12, wherein the calcium oxide or hydroxide is calcium hydroxide.

14. The method of claim 13, wherein at least the portion of the second leachate is reacted with a base to form the calcium hydroxide.

15. The method of claim 14, further comprising producing the base and regenerating the acid using electrolysis.

16. The method of claim 6, further comprising producing a cementitious material using at least a portion of the second solid and the calcium oxide or hydroxide.

17. The method of claim 16, wherein the cementitious material comprises at least a portion of the solid comprising iron and/or aluminum oxides or hydroxides.

18. The method of any one of claims 1-17, reacting at least a portion of the second leachate with a base to form a third solid comprising magnesium oxides or hydroxides.

19. The method of any one of claims 1-18, wherein ferrous ions are precipitated separately through reaction with a base to form either ferrous or ferric oxides or hydroxides.

20. A method of preparing a cementitious material comprising:
reacting a first feed material comprising iron and/or aluminum with an acid to produce a first leachate comprising iron and/or aluminum cations and a first solid comprising silicon;
reacting the first leachate with a second feed material comprising calcium to produce a second leachate comprising calcium cations and a second solid comprising iron and/or aluminum oxides or hydroxides;
reacting at least a portion of the second leachate to form a third solid comprising calcium oxide or hydroxide and a salt solution;
combining a portion of the third solid with a portion of the first and/or second solid to form a cementitious material; and
regenerating the acid using the salt solution.

21. The method of claim 20, wherein the cementitious material comprises the second solid and a sulfate source comprising gypsum, anhydrite, and/or calcium sulfate hemihydrate.

22. The method of claim 20, wherein combining the portion of the third solid with the portion of the first and/or second solid comprises heating the combination in a kiln to create the cementitious material.

23. An acid-base leaching method comprising:
supplying an iron-containing material and an acid to a first reaction chamber to form a first process stream comprising an iron salt;
supplying the first process stream and a calcium source feed material to a second reaction chamber to form a precipitated iron oxide (Fe₂O₃ and/or FeO) product and a second process stream comprising alkaline earth metal salts;
supplying the second process stream and a base to a third reaction chamber to form a precipitated first alkali metal product and a third process stream; and
regenerating the acid using the third process stream.

24. The method of claim 23, wherein the supplying an iron-containing material comprises: supplying an iron source feed material comprising industrial waste directly to the first reactor; or recycling a portion of the iron product to the first reactor.

25. The method of any one of claims 23-24, wherein: the iron salt comprises ferric chloride (FeCl₃); and the first alkali metal product comprises magnesium hydroxide (Mg(OH)₂).

26. The method of claim 25, wherein the acid comprises hydrochloric acid and the base comprises sodium hydroxide.

27. The method of any one of claims 23-26, further comprising forming an insoluble silicon dioxide (SiO₂) or aluminosilicate product in the first reaction chamber.

28. The method of any one of claims 23-27, further comprising supplying the third process stream and the base to a fourth reaction chamber to form a precipitated second alkaline earth metal product and a brine stream and supplying the brine stream to an electrolyzer configured to generate the acid and the base.

29. The method of claim 28, wherein the fourth reaction chamber is maintained at a higher pH than the third reaction chamber by the addition of the base to the fourth reaction chamber.

30. The method of claim 28, further comprising forming a fourth process stream comprising aluminum oxide (Al₂O₃) and silicon dioxide (SiO₂) in the first reactor; supplying the fourth process stream and the base to a fifth reaction chamber to form a fifth process stream comprising dissolved sodium aluminate and a solid silicon dioxide product; supplying the fifth process stream to a sixth reaction chamber to form a precipitated aluminum product comprising aluminum oxide (Al₂O₃) and/or aluminum hydroxide (Al(OH)₃); and heating the base prior to supplying the base to the fifth reaction chamber.

31. The method of claim 30, wherein supplying the fifth process stream to a sixth reaction chamber comprises cooling the sixth reaction chamber, such that chemical reactions occur at a lower temperature in the sixth reaction chamber than in the fifth reaction chamber and the base is supplied to the third reaction chamber from the sixth reaction chamber.

32. The method of claim 30, further comprising blending the silicon dioxide product and the aluminum product to for a pozzolan and using the pozzolan to make a construction material.

33. An acid-base leaching method comprising:
supplying an iron source feed material and an acid to a first reaction chamber to form a first process stream comprising an iron salt and a fourth process stream comprising precipitated silicon dioxide (SiO₂), aluminum hydroxide (Al(OH)₃), and/or aluminum oxide (Al₂O₃);
supplying the first process stream and a calcium source feed material to a second reaction chamber to form a second process stream comprising alkaline earth metal salts and a precipitated iron oxide (Fe₂O₃ and/or FeO) product;
supplying the second process stream and a first ammonia stream to a third reaction chamber to form a third process stream comprising calcium chloride CaCl₂) and ammonium chloride (NH₄Cl) and a precipitated magnesium hydroxide Mg(OH)₂) product;
supplying the third process stream and a base to a fourth reaction chamber to form a precipitated calcium hydroxide Ca(OH)₂ product, a brine stream, and a second ammonia stream;
supplying the brine stream to an electrolyzer configured to generate the acid and a base;
supplying the fourth process stream, an ammonia salt, and the base to a fifth reaction chamber to generate a first ammonia stream and a fifth process stream comprising dissolved silicon dioxide and aluminum oxide;
supplying the fifth process stream and the second ammonia stream to a sixth reaction chamber to form a precipitated aluminosilicate product and the dissolved ammonia salt; and
regenerating the acid from the brine stream.

34. The method of claim 33, wherein the ammonia salt comprises ammonium fluoride (NH₄F) and/or ammonium bifluoride (NH₄F₂).

35. The method of any one of claims 33-34, further comprising using the calcium hydroxide product and the aluminosilicate product to form a construction material.

36. An acid-base leaching method comprising:
supplying calcium sulfate (CaSO₄) and an acid to a first reaction chamber to form a first process stream comprising calcium ions (Ca⁺) and bisulfate ions (2HSO₄⁻) and a solid silicon dioxide (SiO₂) product;
supplying the first process stream and iron oxide (Fe₂O₃) to a second reaction chamber to form a second process stream comprising ferric chloride (FeCl₃) and precipitated calcium sulfate (CaSO₄) product;
supplying the second process stream and aluminum oxide (Al₂O₃) to a third reaction chamber to form a third process stream comprising aluminum chloride (AlCl₃) and a precipitated iron oxide product;
supplying the third process stream and a feed material to a fourth reaction chamber to form a fourth process stream comprising alkaline earth metal salts and a precipitated aluminum oxide product;
supplying the fourth process stream and a base to a fifth reaction chamber to form a fifth process stream comprising calcium chloride and a precipitated magnesium hydroxide Mg(OH)₂) product;
supplying the fifth process stream and a base to a sixth reaction chamber to form a brine stream and a precipitated calcium hydroxide Ca(OH)₂ product; and
providing the brine stream to an electrolyzer to generate the acid and the base

37. The method of claim 36, wherein the calcium sulfate provided to the first reaction chamber is recycled from the calcium sulfate product; the iron oxide provided to the second reaction chamber is recycled from the iron oxide product; and the aluminum oxide provided to the third reaction chamber is recycled from the aluminum oxide product.

38. The method of any one of claims 36-37, further comprising controlling the pH of each reaction chamber, such that the first reaction chamber has the lowest pH and the second, third, fourth, fifth, and sixth reaction chambers have successively higher pH's.

39. The method of claim 38, wherein the pH of the first chamber ranges from about −0.5 to about −1.5; the pH of the fifth chamber ranges from about 9.5 to about 10.5; and the pH of the sixth chamber ranges from about 12 to about 13.

40. An acid-base leaching method comprising:
supplying calcium sulfate (CaSO₄) and an acid to a first reaction chamber to form a first process stream comprising calcium ions (Ca⁺) and bisulfate ions (2HSO₄⁻) and a solid silicon dioxide (SiO₂) product;
supplying the first process stream and iron source feed material to a second reaction chamber to form a second process stream comprising ferric chloride (FeCl₃) and precipitated calcium sulfate (CaSO₄) product;
supplying the second process stream and aluminum source feed material to a third reaction chamber to form a third process stream comprising aluminum chloride (AlCl₃) and a precipitated iron oxide product;
supplying the third process stream and a calcium source feed material to a fourth reaction chamber to form a fourth process stream comprising alkaline earth metal salts and a precipitated aluminum oxide product;
supplying the fourth process stream and a base to a fifth reaction chamber to form a fifth process stream comprising calcium chloride and a precipitated magnesium hydroxide Mg(OH)₂) product;
supplying the fifth process stream and a base to a sixth reaction chamber to form a brine stream and a precipitated calcium hydroxide Ca(OH)₂ product; and
providing the brine stream to an electrolyzer to generate the acid and the base.

41. The method of claim 40, wherein the iron source feed material, the aluminum source feed material, and the calcium source feed material are industrial waste products.

42. The method of any one of claims 40-41, further comprising controlling the pH of each reaction chamber, such that the first reaction chamber has the lowest pH and the second, third, fourth, fifth, and sixth reaction chambers have successively higher pH's.

43. An acid-base leaching method comprising:
supplying an acid, a silica source feed material, and a silica recycle stream to a first reaction chamber to generate a first process stream comprising unreacted acid and to generate a fifth process stream comprising crystalline silica;
supplying the first process stream, a calcium and magnesium source feed material, an Fe/Al/Si recycle stream comprising amorphous silica, iron hydroxide (Fe(OH)₂ and/or Fe(OH)₃), aluminum oxide (Al₂O₃), and/or aluminum hydroxide (Al₂(OH)₃), and an iron and aluminum source feed material, to a second reaction chamber to generate an amorphous silica product and to generate a second process stream comprising an aluminum salt and an iron salt, wherein the silica recycle stream comprises a portion of the amorphous silica product;
supplying the second process stream, a decarbonated calcium and magnesium source feed material, and a calcium carbonate source feed material to a third reaction chamber to generate a third process stream comprising a calcium salt and a magnesium salt and to generate a seventh process stream comprising amorphous silica, iron hydroxide, aluminum hydroxide, and/or aluminum oxide, wherein the Fe/Al/Si recycle stream comprises a portion of the seventh process stream;
supplying the fifth process stream and an ammonia salt to a sixth reaction chamber to generate ammonia, a sixth process stream comprising aqueous silica, and a rare earth element and/or platinum group metal product; and
supplying the sixth process stream and the ammonia to a seventh reaction chamber to generate an amorphous silica product and the ammonia salt,
wherein the sixth reaction chamber has a lower pressure and/or temperature than the seventh reaction chamber to promote the condensation of the ammonia in the sixth reaction chamber.

44. The method of claim 43, further comprising supplying the seventh process stream and a base to an eighth reaction chamber to generate an eighth process stream comprising an aluminum salt and to generate an Fe/Si product comprising iron hydroxide (Fe(OH)₂ and/or Fe(OH)₃) and amorphous silica; and supplying the eighth process stream to a nineth reaction chamber to generate aluminum hydroxide and the base, wherein the eighth reaction chamber is maintained at a higher temperature than the nineth reaction chamber, in order to promote the generation of the aluminum salt.

45. The method of claim 44, further comprising supplying the Fe/Si product to a separation device to generate an amorphous silica product and an iron hydroxide (Fe(OH)₂ and/or Fe(OH)₃) product.

46. The method of any one of claims 43-45, further comprising supplying the third process stream and the base to a fourth reaction chamber to generate a magnesium oxide product and a fourth process stream comprising a calcium salt; and supplying the base and the fourth process stream to a fifth reaction chamber to generate brine and a calcium hydroxide product.
